(19) United States
(12) Patent Application Publication
(10) Pub. No.: US 2026/0323442 A1
(43) Pub. Date: Oct. 15, 2026

(54) ENHANCEMENTS FOR SCG LTM

(71) Applicant: QUALCOMM Incorporated, San Diego, CA (US)

(72) Inventors: Shankar KRISHNAN, Poway, CA (US); Punyaslok PURKAYASTHA, San Diego, CA (US); Ozcan OZTURK, San Diego, CA (US); Jelena DAMNJANOVIC, Del Mar, CA (US); Doohyun SUNG, Basking Ridge, NJ (US); Prasada Veera Reddy KADIRI, San Diego, CA (US)

(21) Appl. No.: 19/180,018

(22) Filed: Apr. 15, 2025

(51) Int. Cl. H04W 36/08; H04W 36/00; H04W 36/30

(52) U.S. Cl. CPC H04W 36/08; H04W 36/0077; H04W 36/305

(57) ABSTRACT

A method for wireless communication at a user equipment (UE) and related apparatus are provided. In the method, a UE has dual connectivity with a master cell group (MCG) and a secondary cell group (SCG). The UE receives, from a network entity, a configuration for a lower-layer-triggered mobility (LTM) with the SCG. The UE further sends a report based on the determination of the failure or the near failure of the LTM with the SCG. The report includes one of a failure report corresponding to the failure or the near failure of the LTM with the SCG or a successful primary serving cell (PSCell) change report (SPR) for the LTM with the SCG. The report includes measurement information and timing information associated with the LTM with the SCG.

### TECHNICAL FIELD

The present disclosure relates generally to communication systems and, more particularly, to lower-layer-triggered mobility (LTM) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to receive, from a network entity, a configuration for a lower-layer-triggered mobility (LTM) with a secondary cell group (SCG), where the UE has dual connectivity with a master cell group (MCG) and the SCG; and send, based on a determination of a failure or a near failure of the LTM with the SCG, a report, where the report includes one of a failure report corresponding to the failure or the near failure of the LTM with the SCG or a successful primary serving cell (PSCell) change report (SPR) for the LTM with the SCG, where the report includes measurement information and timing information associated with the LTM with the SCG.

In an aspect of the disclosure, a method, a computer-readable medium, and an apparatus are provided for wireless communication at a secondary node of a network entity. The apparatus may include at least one memory and at least one processor coupled to the at least one memory. Based at least in part on information stored in the at least one memory, the at least one processor may be configured to receive, at a central node (CU) of the secondary node from the CU of a master node, a failure report indicating a failure of an SCG of a UE due to a PSCell change, where the failure report includes a PSCell change type indicator; and transmit, from the CU of the secondary node to a distributed unit (DU) of the secondary node, the PSCell change type indicator and an SCG failure type corresponding to the failure of the SCG.

In an aspect of the disclosure, a method, a computer-readable medium, and an apparatus are provided for wireless communication at a master node of a network entity. The apparatus may include at least one memory and at least one processor coupled to the at least one memory. Based at least in part on information stored in the at least one memory, the at least one processor may be configured to receive, at a DU of the master node from a CU of the master node, an MCG failure information indicating a radio link failure (RLF) of a UE; and transmit, from the DU of the master node to the CU of the master node, cell switch information based on the MCG failure information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example entities in dual connectivity.

FIG. 5 is a diagram illustrating an example of dual connectivity of a UE.

FIG. 6 is a diagram illustrating example cell groups of dual connectivity of a UE.

FIG. 7A is a diagram illustrating an example enhancement to the secondary cell group (SCG) failure information in accordance with various aspects of the present disclosure.

FIG. 7B is a diagram illustrating example enhancements to successful PSCell change report (SPR) for lower-layer-triggered mobility (LTM) in accordance with various aspects of the present disclosure.

FIG. 8 is a diagram illustrating example enhancements for the F1 interface communication in accordance with various aspects of the present disclosure.

FIG. 9 is a diagram illustrating example enhancements for the F1 interface communication in accordance with various aspects of the present disclosure.

FIG. 10 is a diagram illustrating example enhancements for the F1 interface communication in accordance with various aspects of the present disclosure.

FIG. 11 is a diagram illustrating example enhancements for the F1 interface communication in accordance with various aspects of the present disclosure.

FIG. 12A is a diagram illustrating example enhancements for the Xn interface communication in accordance with various aspects of the present disclosure.

FIG. 12B is a diagram illustrating example enhancements for the Xn interface communication in accordance with various aspects of the present disclosure.

FIG. 13 is a diagram illustrating example enhancements for the Xn interface communication in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a UE in accordance with various aspects of the present disclosure.

FIG. 16 is a flowchart illustrating methods of wireless communication at a secondary node of a network entity in accordance with various aspects of the present disclosure.

FIG. 17 is a flowchart illustrating methods of wireless communication at a secondary node of a network entity in accordance with various aspects of the present disclosure.

FIG. 18 is a flowchart illustrating methods of wireless communication at a master node of a network entity in accordance with various aspects of the present disclosure.

FIG. 19 is a diagram illustrating an example of a hardware implementation for an example apparatus and/or UE.

FIG. 20 is a diagram illustrating an example of a hardware implementation for an example network entity.

### DETAILED DESCRIPTION

In a wireless communication system, the UE may be configured to be simultaneously connected to a primary cell group (e.g., an MCG) and a secondary cell group (e.g., an SCG), an arrangement referred to as dual connectivity. To ensure that a UE maintains continuous connectivity with a network entity (e.g., a base station) under changing network conditions, a lower-layer-triggered mobility (LTM), such as layer 1 or layer 2 (L1/L2) mobility, may be used to reduce mobility latency. LTM allows a UE to switch or reconfigure its serving cell based on lower-layer measurements (e.g., L1 or L2 measurements), without resorting a more time-consuming layer 3 (L3) handover procedure (e.g., using radio resource control (RRC) signaling). Example aspects presented herein provide enhancements to parameters and information sent during SCG LTM execution in various types of signaling.

Various aspects relate generally to wireless communication. Some aspects more specifically relate to enhancements to LTM in wireless communication. In some examples, a UE receives, from a network entity, a configuration for an LTM with an SCG, where the UE has dual connectivity with an MCG) and the SCG. The UE further sends, based on a determination of a failure or a near failure of the LTM with the SCG, a report. The report includes one of a failure report corresponding to the failure or the near failure of the LTM with the SCG or a successful primary serving cell (PSCell) change report (SPR) for the LTM with the SCG. The report includes measurement information and timing information associated with the LTM with the SCG. In some examples, the report may include the failure report, and the measurement information associated with the LTM with the SCG may include one or more of: layer 1 (L1) or layer 3 (L3) measurements for a serving PSCell or a target PSCell, the L1 or L3 measurements for one or more neighboring PSCells, or the L1 or L3 measurements for one or more LTM candidate PSCells. The timing information associated with the LTM with the SCG may include one or more of: a timer, or a timing advance (TA) acquisition type for the LTM with the SCG. In some examples, the report may include the SPR for the LTM with the SCG, and the UE may determine whether one or more SPR criteria have been met; and collect SPR information, which may be included in the measurement information. In some examples, the SPR may include one or more of: the initiating node for the SCG LTM, the type of PSCell change, L1 measurements, L3 measurements, or a timer representing the time elapsed since an execution of the SCG LTM until an SCG failure.

Particular aspects of the subject matter described in this disclosure can be implemented to realize one or more of the following potential advantages. In some examples, by enhancing signaling mechanisms and improving the content and reporting of SCG failure information over various network interfaces, such as Uu, F1, or Xn interfaces, the described techniques improve the accuracy and efficiency of mobility procedures in wireless communication (e.g., in dual connectivity networks), thereby enhancing overall network stability. In some examples, by supporting co-existence of SCG and MCG LTM configurations and facilitating communication of LTM configuration information between network nodes, the described techniques improve inter-node coordination and help prevent unnecessary or incorrect mobility actions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

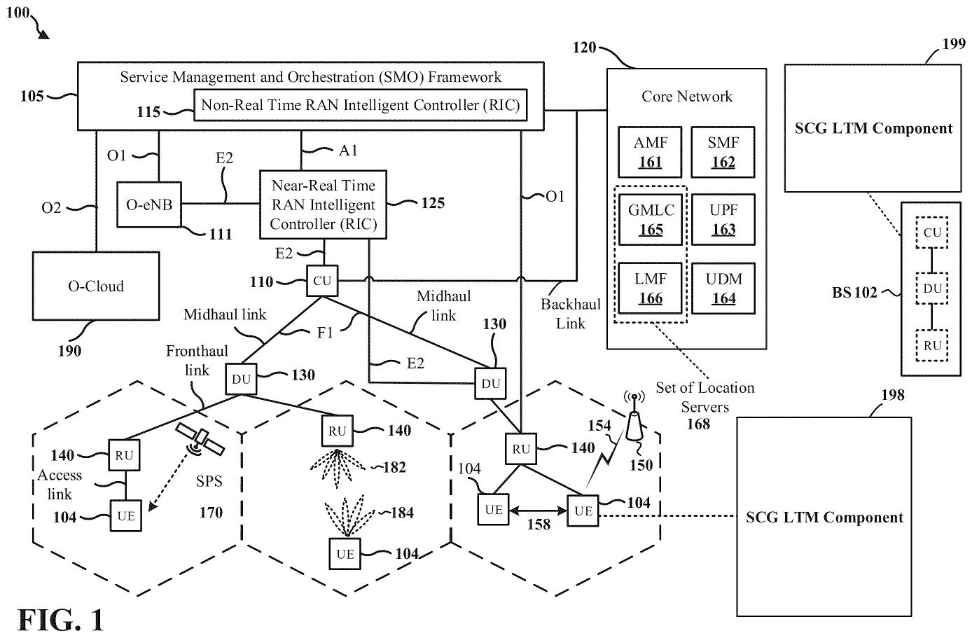

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the SCG LTM component 198. The SCG LTM component 198 may be configured to receive, from a network entity, a configuration for an LTM with an SCG, where the UE has dual connectivity with an MCG and the SCG; and send, based on a determination of a failure or a near failure of the LTM with the SCG, a report, where the report includes one of a failure report corresponding to the failure or the near failure of the LTM with the SCG or an SPR for the LTM with the SCG. The report includes measurement information and timing information associated with the LTM with the SCG. In certain aspects, the base station 102 may include the SCG LTM component 199. In some examples, the SCG LTM component 199 may be configured to receive, at a CU of the secondary node from the CU of a master node, a failure report indicating a failure of an SCG of a UE due to a PSCell change, where the failure report includes a PSCell change type indicator; and transmit, from the CU of the secondary node to a DU of the secondary node, the PSCell change type indicator and an SCG failure type corresponding to the failure of the SCG. In some examples, the SCG LTM component 199 may be configured to receive, at a DU of the master node from a CU of the master node, an MCG failure information indicating an RLF of a UE; and transmit, from the DU of the master node to the CU of the master node, cell switch information based on the MCG failure information. Although the following description may be focused on 5G NR, the concepts described herein may be applicable to other similar areas, such as LTE, LTE-A, CDMA, GSM, and other wireless technologies.

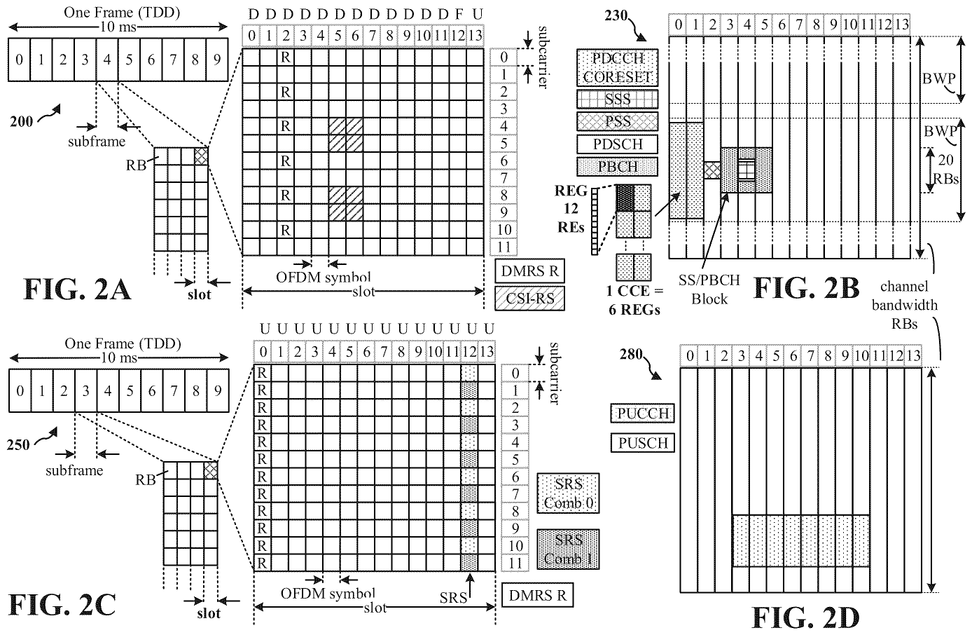

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

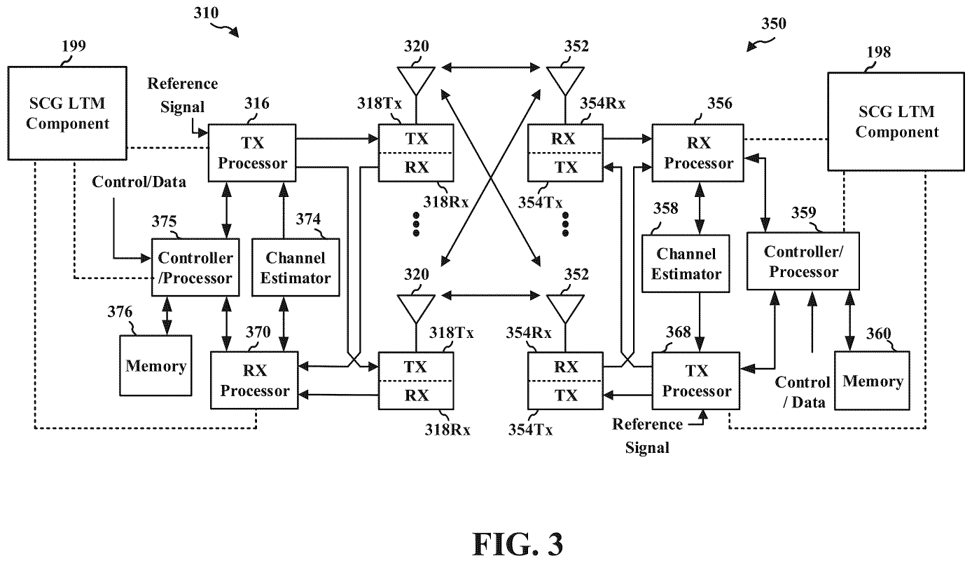

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SCG LTM component 198 of FIG. 1.

At least one of the TX processor 316, the RX processor 370, and the controller/processor 375 may be configured to perform aspects in connection with the SCG LTM component 199 of FIG. 1.

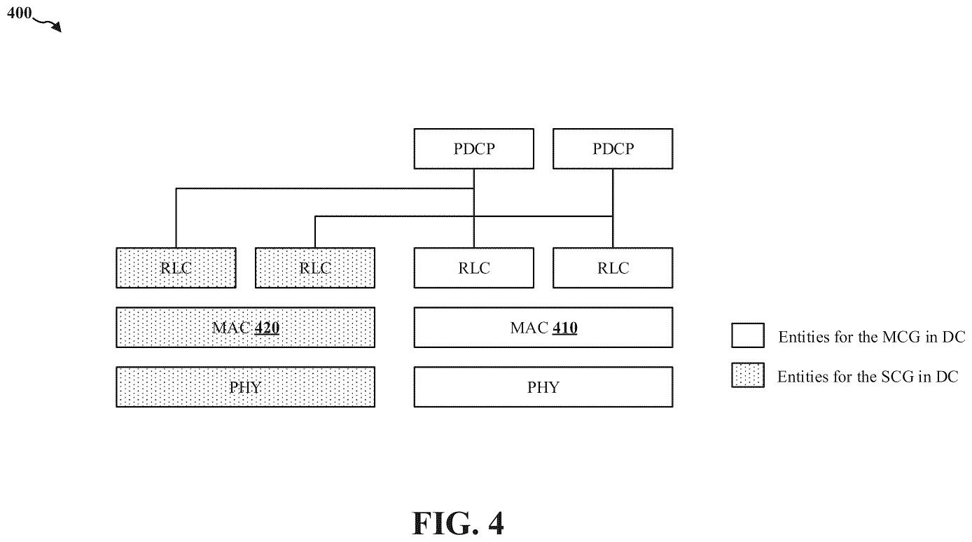

Dual connectivity (DC) can be configured for a UE for wireless communications, such as those involving 4G and 5G networks. In dual connectivity, the UE may be configured to be simultaneously connected to a primary cell group (e.g., an MCG) and a secondary cell group (e.g., an SCG). When the UE is configured with an SCG, the UE may operate with two medium access control (MAC) entities: one for the MCG and another for the SCG. This configuration enables the UE to maintain the connections with multiple cells simultaneously to enhance data throughput and network reliability. In some examples, DC may also be deployed to support operations across multiple frequency bands. FIG. 4 is a diagram 400 illustrating example entities in dual connectivity. As shown in FIG. 4, a UE in dual connectivity may operate with two MAC entities (e.g., MAC 410 and 420): one MAC (e.g., MAC 410) for the MCG and another MAC (e.g., MAC 420) for the SCG.

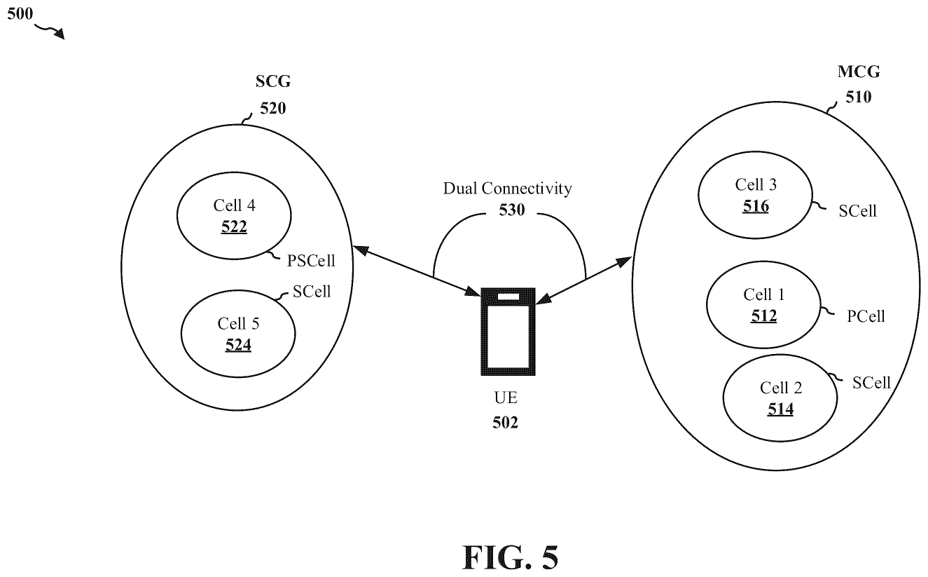

FIG. 5 is a diagram 500 illustrating an example dual connectivity of a UE. As shown in FIG. 5, a UE 502 may be in dual connection (e.g., 530) with an MCG 510 and an SCG 520. The MCG 510 may include a PCell (e.g., cell 1 512) and one or more secondary cells (e.g., cell 2 514, cell 3 516). The SCG 520 may include a PSCell (e.g., cell 4 522) and one or more secondary cells (e.g., cell 5 524). In some examples, the UE 502 may transition the SCG 520 between activated, deactivated, and dormant states.

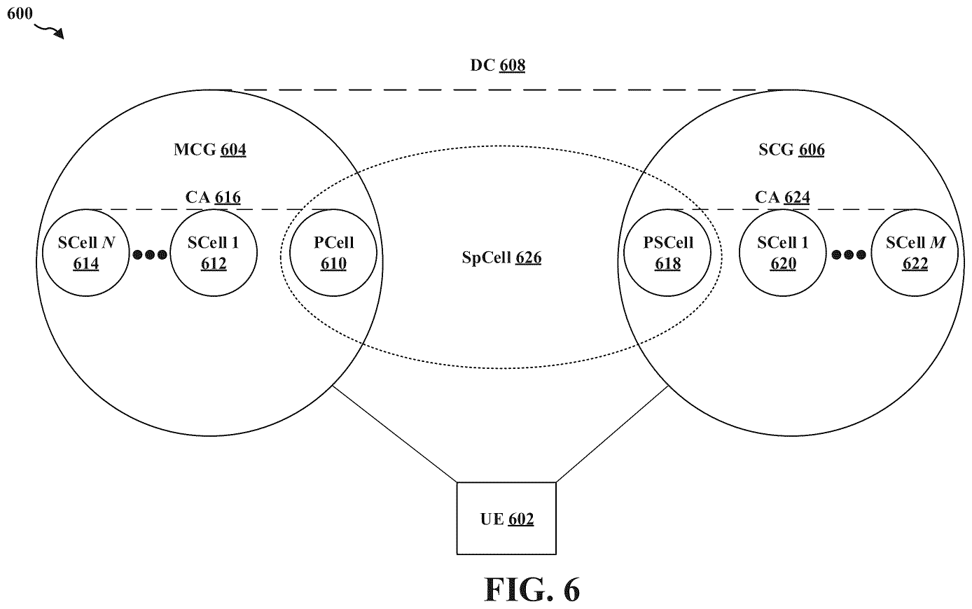

FIG. 6 is a diagram 600 that illustrates example cell groups of dual connectivity of a UE. As shown in FIG. 6, in the dual connectivity arrangement 608, a UE 602 may be connected to a master cell group (MCG) 604 and a secondary cell group (SCG) 606. The MCG 604 may be a group of serving cells associated with a master node that has a control plane connection to a core network (e.g., the core network 120). The master node may be a base station such as a gNB, an eNB, etc. (i.e., a network entity). The SCG 606 may be a group of serving cells associated with a secondary node that does not have a control plane connection to the core network. The secondary node may be a base station, such as a gNB, an eNB, etc. (i.e., a network entity). The MCG 604 may become the SCG 606 and the SCG 606 may become the MCG 604 based upon various factors, such as a location of the UE 602, network conditions, etc.

The MCG 604 includes a PCell 610. The MCG 604 may also include one or more SCells (e.g., a first SCell 612 through an Nth SCell 614, where Nis a positive integer greater than one). The PCell 610, the first SCell 612, and/or the Nth SCell 614 may be in a CA 616 configuration. In some aspects, a primary cell may become a secondary cell or that a secondary cell may become a primary cell based upon various factors, such as a location of the UE 602, network conditions, etc.

The SCG 606 includes a primary secondary cell (PSCell) 618. The PSCell 618 is a primary cell of the SCG 606. The SCG 606 may also include one or more SCells (e.g., a first SCell 620 through an Mth SCell 622, where M is a positive integer greater than one). The PSCell 618, the first SCell 620, and/or the Mth SCell 622 may be in a CA configuration 624. In some aspects, a primary secondary cell may become a secondary cell or that a secondary cell may become a primary secondary cell based upon various factors, such as a location of the UE 602, network conditions, etc. The PCell 610 of the MCG 604 and the PSCell 618 of the SCG 606 may be referred to as a special cell (SpCell) 626.

In a wireless communication system, to ensure that a UE maintains continuous connectivity with a network entity (e.g., a base station) under changing network conditions (e.g., when the UE is moving within a network), a lower-layer-triggered mobility (LTM), such as layer 1 or layer 2 (L1/L2) mobility, may be used to reduce mobility latency. LTM allows a UE to switch or reconfigure its serving cell based on lower-layer measurements (e.g., L1 or L2 measurements), without resorting a more time-consuming layer 3 (L3) handover procedure (e.g., using RRC signaling). LTM may be applicable to standalone operation scenarios, CA scenarios, and DC (e.g., NR-DC) scenarios. Example aspects presented herein provide enhancements to parameters and information sent during LTM execution in three types of signaling. The first type of signaling is between the UE and the base station (e.g., gNB). The second type is between the CU and the DU, also referred to as F1 signaling, and the third type is between the master node (MN) and the secondary node (SN), also referred to as X1 signaling.

In some aspects, the enhancements to parameters and information may include Uu enhancements, including the enhancements to SCG failure information (e.g., via message SCGFailureInformation) and enhancements to the successful PSCell change report (SPR) for SCG LTM. In some aspects, the enhancements to parameters and information may include F1 enhancements, which relate to the interaction between the CU and DU. For example, as part of the F1 enhancements, the secondary node central unit (SN-CU) may detect the type of SCG failure (e.g., whether it is a layer 3 (L3) SCG failure or an LTM SCG failure) and inform the secondary node distributed unit (SN-DU) of the type of SCG LTM failure. In some examples, the SN-CU may forward the SCG UE history information (UHI) to the SN-DU. In some examples, the SN-CU may forward MCG failure information (e.g., via message MCGFailureInformation) to the SN-DU, and the master node (MN) may send updated MCG LTM configurations or an MCG LTM cell switch command (CSC) via the secondary node. In some aspects, the enhancements to parameters and information may include Xn enhancements. For example, as part of the Xn enhancements, the secondary node may inform the master node about SCG LTM configuration that was sent or released over a signal radio bearer 3 (SRB3) to support the co-existence of MCG LTM and SCG LTM. In some examples, the master node may inform the secondary node about MCG LTM configuration that was sent or released over a signal radio bearer 1 (SRB1) to support the co-existence of MCG LTM and SCG LTM. In some examples, the master node may assist the source secondary node with UE context and SCG LTM configurations in cases where the source secondary node deletes them, when performing SCG LTM related optimizations.

In some aspects, Uu enhancement for the SCG LTM may include defining various SCG LTM failure scenarios that may arise during the execution of SCG LTM. One SCG LTM failure may be referred to as “Too Late SCG LTM Execution.” In this case, the UE receives the SCG LTM configuration, but an SCG failure occurs before the SCG LTM execution condition is satisfied. In this scenario, a suitable PSCell different from the source PSCell may be found based on the Layer 3 (L3) and/or Layer 1 (L1) measurements (whichever is configured) reported from the UE via parameter SCG failure information (e.g., via message SCGFailureInformation). The suitable PSCell may or may not be among the list of candidate cells.

Another SCG LTM failure may be referred to as “Too Early SCG LTM Execution,” which occurs when the SCG LTM execution is not successful or when an SCG failure occurs shortly after a successful SCG LTM execution. In this scenario, the source PSCell is still considered the suitable PSCell based on the L3 and/or L1 measurements (whichever is configured) reported by the UE.

Another SCG LTM failure may be referred to as “SCG LTM Execution to Wrong PSCell,” which occurs when SCG LTM execution is not successful or when an SCG failure occurs shortly after a successful SCG LTM execution, and a suitable PSCell different from the source PSCell or the target PSCell is found based on the L3 and/or L1 measurements reported by the UE. In this scenario, if the suitable PSCell is one of the candidate target PSCells provided by the node initiating the SCG LTM (i.e., the source secondary node (SN)), but is not one of the candidate PSCells selected by the candidate or target SN, then the SCG LTM failure may be classified as a wrong target PSCell selection at the candidate or target SN. On the other hand, if the suitable PSCell is not one of the candidate target PSCells provided by the source SN, the SCG LTM failure may be classified as a wrong candidate PSCell list selection at the node initiating the SCG LTM. As used herein, the term “successful SCG LTM execution” refers to either the successful completion of the random access (RA) procedure on the SCG in the case of RACH-based SCG LTM, or the receipt of confirmation of the first uplink (UL) data (e.g., SN RRCReconfigComplete message) sent in the case of RACH-less SCG LTM.

In some aspects, the SCG LTM failures may be detected in various ways. For example, the SCG LTM failure of “Too Late SCG LTM Execution” may be detected when SCG LTM is configured, but there is no recent SCG LTM execution for the UE prior to a connection failure. This SCG LTM failure may be identified, for example, when the UE-reported timer is absent or larger than the configured threshold (e.g., Tstore_UE_cntxt), and there is a suitable PSCell different from the PSCell where the UE is located at the time of the failure occurrence.

For example, the SCG LTM failure of “Too Early SCG LTM Execution” may be detected when there is a recent SCG LTM execution for the UE before the connection failure. This SCG LTM failure may be identified, for example, when the UE-reported timer is smaller than the configured threshold (e.g., Tstore_UE_cntxt), and the source PSCell is determined to be a suitable PSCell.

For example, the SCG LTM failure of “SCG LTM Execution to Wrong PSCell” may be detected when there is a recent SCG LTM execution for the UE prior to the connection failure. This SCG LTM failure may be identified, for example, when the UE-reported timer is smaller than the configured threshold (e.g., Tstore_UE_cntxt), and the suitable PSCell is not the source PSCell or the target PSCell. In the above examples, the UE-reported timer may refer to the time elapsed from the SCG LTM execution to the occurrence of the SCG failure.

In some examples, other than the SCG LTM failure scenarios described above, the SCG LTM “near failure” scenarios may occur during the execution of SCG LTM. The SCG LTM “near failure” scenarios refer to the situations in which the SCG LTM is executed and completed, but its execution (e.g., its timing) is too close to an SCG LTM that can be classified as a failure. These SCG LTM “near failure” scenarios may correspond to the SCG LTM failure scenarios. For example, the SCG LTM “near failure” scenario corresponding to the SCG LTM failure of “Too Late SCG LTM Execution” may be identified when the UE-reported timer for the SCG LTM is less than the configured threshold (e.g., Tstore_UE_cntxt), but still within a failure margin of the configured threshold (e.g., Tstore_UE_cntxt), and there is a suitable PSCell different from the PSCell where the UE is located at the time of the failure occurrence. The SCG LTM “near failure” scenario corresponding to the SCG LTM failure of “Too Early SCG LTM Execution” may be identified when the UE-reported timer for the SCG LTM is larger than the configured threshold (e.g., Tstore_UE_cntxt), but within the failure margin to the configured threshold (e.g., Tstore_UE_cntxt), and the source PSCell is determined to be a suitable PSCell.

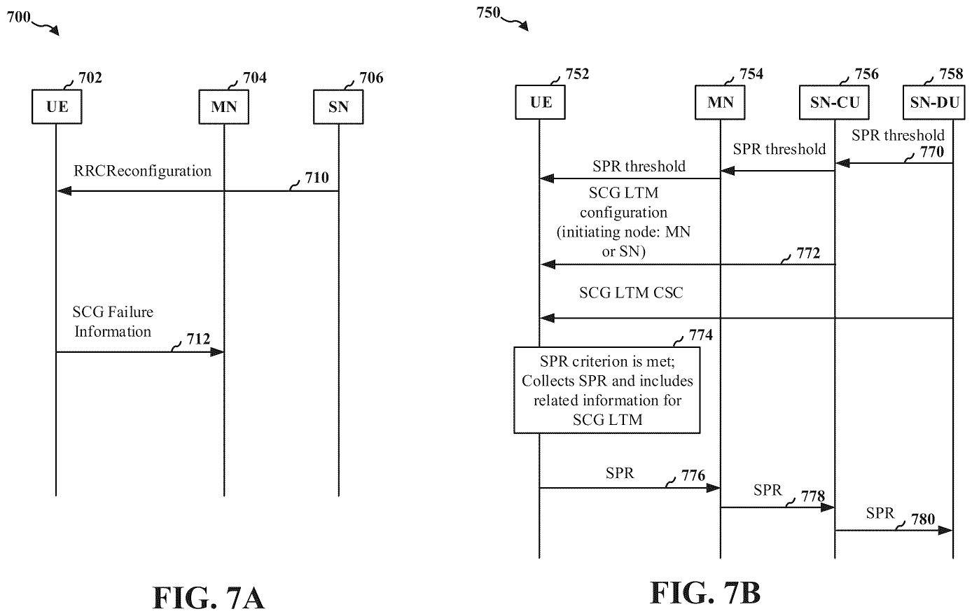

Some example aspects provide enhancements to SCG failure information (e.g., message SCGFailureInformation) to support improved detection and analysis of SCG LTM failures and near failures scenarios. While some example aspects may use SCG LTM failures as example, the same principles that apply to the SCG LTM failure scenarios are also applicable to the SCG LTM “near failures” scenarios. FIG. 7A is a diagram 700 illustrating an example enhancement to the SCG failure information in accordance with various aspects of the present disclosure. As shown in FIG. 7A, the network (e.g., SN 706) may send an RRC message (e.g., RRCReconfiguration message) to the UE 702 at 710, prior to the occurrence of the SCG failure. In this RRC message (e.g., RRCReconfiguration message), the network (e.g., SN 706) may configured the type of measurements (e.g., L1 measurements, L3 measurements, or a combination of both) to be reported by the UE 702 in the SCG failure information (e.g., via message SCGFailureInformation). In some examples, the RRC message may further include other configurations or information, such as an LTM configuration, an L1 measurement configuration for LTM, or an L3 measurement configuration for LTM.

Based on the indication received in the RRC message (e.g., RRCReconfiguration message) at 710, the UE 702 may include the corresponding measurements (e.g., L1 measurements, L3 measurements, or a combination of both) in the SCG failure information (e.g., message SCGFailureInformation) reported to the network (e.g., MN 704) at 712.

For example, the SCG failure information (e.g., message SCGFailureInformation) the UE 702 reports to the network (e.g., MN 704) may include a new failure type identified as, for example, “LTM Failure SCG,” which may be different from the types representing a L3 SCG failure. In some examples, the SCG failure information (e.g., message SCGFailureInformation) may include an indication specifying whether the last PSCell change was the result of an LTM cell switch or not, which would help distinguish LTM-based changes from L3 PSCell changes.

In some examples, the SCG failure information (e.g., message SCGFailureInformation) may include L3 measurements for the serving PSCell, the target PSCell, one or more neighboring PSCells, and one or more other LTM candidate PSCells. In some examples, the SCG failure information (e.g., message SCGFailureInformation) may include the time elapsed since the SCG LTM execution until the SCG failure, an indication (e.g., a first indication) that the UE was configured with SCG LTM configuration before the SCG failure, either explicitly or implicitly, an indication (e.g., a second indication) of whether each neighbor PSCell was considered an LTM candidate, and a set of LTM candidate PSCells that the UE (e.g., UE 702) had at the time of the SCG failure. In some examples, the SCG failure information (e.g., message SCGFailureInformation) may further include the timing advance (TA) acquisition type used for SCG LTM. For example, the TA acquisition may be one of a network-provided TA or a UE-based TA.

In some examples, the SCG failure information (e.g., message SCGFailureInformation) may further include the access type used during the SCG LTM, specifying whether it was RACH-based or RACH-less, the previous PSCell identifier (ID) and the failed PSCell ID to track the mobility path and, in cases of RACH-based SCG LTM failure, RACH information. In some examples, the SCG failure information (e.g., message SCGFailureInformation) may further include L1 measurements for the serving PSCell, the target PSCell, and other LTM candidate PSCells.

In some aspects, when a PSCell change (e.g., an L3 PSCell change) is successfully completed, the UE may collect a successful PSCell change report (SPR). For example, for an L3 PSCell change, the UE may collect an SPR when specific conditions related to SCG timers are met (e.g., when the SCG timers are greater than a threshold, which may be referred to as “SPR threshold” in some aspects). In some examples, a UE may be configured with two SPR configurations, one provided by the master node (MN) and the other by the secondary node (SN), and an RRC message (e.g., RRCReconfiguration message at 710) may specify the type of PSCell change (whether it is MN-initiated PSCell change or SN-initiated PSCell change). Based on this configuration, the UE may include the type of PSCell change in the SPR. This allows the appropriate node (e.g., MN or SN) to identify the initiating node of the PSCell change and perform the SPR optimizations accordingly.

Some example aspects provide enhancements to the SPR for LTM to enable more effective mobility event handling in SCG scenarios. FIG. 7B is a diagram 750 illustrating example enhancements to SPR for LTM in accordance with various aspects of the present disclosure.

As shown in FIG. 7B, one or more SPR thresholds may be configured by the secondary node-distributed unit (SN-DU 758). For example, the SPR may be collected when the timing advance (TA) is invalid or when the UE has tried a predefined number (e.g., N) of times in the indicated beam in SCG LTM cell switch command (CSC). In such cases, the one or more SPR thresholds defined by the SN-DU 758 may be sent, at 770, to the secondary node-central unit (e.g., SN-CU 756). Upon receiving the one or more SPR thresholds, the SN-CU 756 may send the one or more SPR thresholds to the UE 752, either via the master node (e.g., MN 754) over SRB1 or over SRB3.

In some aspects, the RRCReconfiguration message that includes the SCG LTM configuration (e.g., at 772), or another suitable RRC message, may also include information about the initiating node, indicating whether the PSCell change was MN-initiated or SN-initiated.

In some aspects, when the configured one or more SPR thresholds are met (e.g., when a timer associated with the SCG exceeds the one or more SPR thresholds), which may be referred to as meeting “the SPR criterion” in some aspects, the UE 752 may, at 774, collect the SPR and include related information for SCG LTM in the SPR. The related information may include, for example, the identity of the initiating node for the SCG LTM (e.g., SN or MN), the type of PSCell change (e.g., whether it is an LTM PSCell change or an L3 PSCell change), L1 and/or L3 measurements, and relevant timers, which may represent the time interval between SCG LTM execution and SCG failure. The UE 752 may send the SPR, including related information such as the initiating node for the SCG LTM, the type of PSCell change, to the MN 754 at 776.

In some examples, depending on the initiating node (e.g., MN or SN), the forwarding behavior of the SPR at the MN 754 may vary. For example, if the initiating node was the SN, the MN 754 may forward the SPR to the SN (e.g., via 778). In some examples, If the initiating node was the MN, then the MN 754 may perform the SPR optimization.

In some examples, if the type of PSCell change is LTM and the SPR was collected due to a threshold provided by the DU (e.g., SN-DU 758), the CU (e.g., SN-CU 756) may forward, at 780, the SPR to the DU (e.g., SN-DU 758). Otherwise, the CU (e.g., SN-CU 756) may not forward the SPR to the DU (e.g., SN-DU 758).

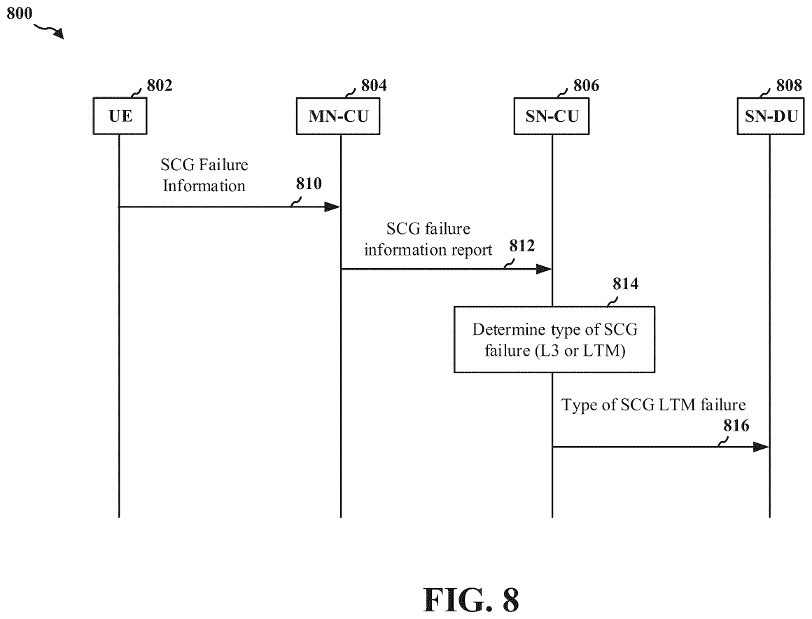

Some example aspects provide enhancements for F1 interface communication between a DU (e.g., SN-DU) and a CU (e.g., SN-CU). FIG. 8 is a diagram 800 illustrating example enhancements for the F1 interface communication in accordance with various aspects of the present disclosure. As shown in FIG. 8, when a SCG failure occurs, the UE 802 may send SCG failure information (e.g., via SCGFailureInformation message) to the MN (e.g., MN-CU 804) at 810, which may forward the SCG failure information to the SN-CU (e.g., SN-CU 806) at 812. Upon receiving the SCG failure information (e.g., SCGFailureInformation message) at 812, the SN-CU (e.g., SN-CU 806) may, at 814, determine the type of SCG failure based on the SCG failure information (e.g., SCGFailureInformation message). For example, the type of SCG failure may be an L3 SCG failure or an LTM SCG failure. This determination may be based on an indication provided by the UE within the SCG failure information (e.g., SCGFailureInformation message).

If the SN-CU (e.g., SN-CU 806) has determined the type of SCG failure is SCG LTM failure, the SN-CU (e.g., SN-CU 806) may, at 816, inform the SN-DU (e.g., SN-DU 808) of the specific type of SCG LTM failure, so that the SN-DU (e.g., SN-DU 808) may take appropriate actions. For example, the type of SCG LTM failure reported from the SN-CU to the SN-DU (e.g., at 816) may include ““Too Early SCG LTM Execution,” “Too Late SCG LTM Execution,” or “SCG LTM Execution to Wrong PSCell.” In some aspects, if the type of SCG LTM failure is “SCG LTM Execution to Wrong PSCell,” SN-CU 806 may further include the cause of SCG LTM failure when reporting the type of SCG LTM failure to the SN-DU 808 at 816. For example, the cause of SCG LTM failure may be due to a wrong target PSCell selection occurring at the candidate or target secondary node (SN), or a wrong candidate PSCell list selection made at the source SN.

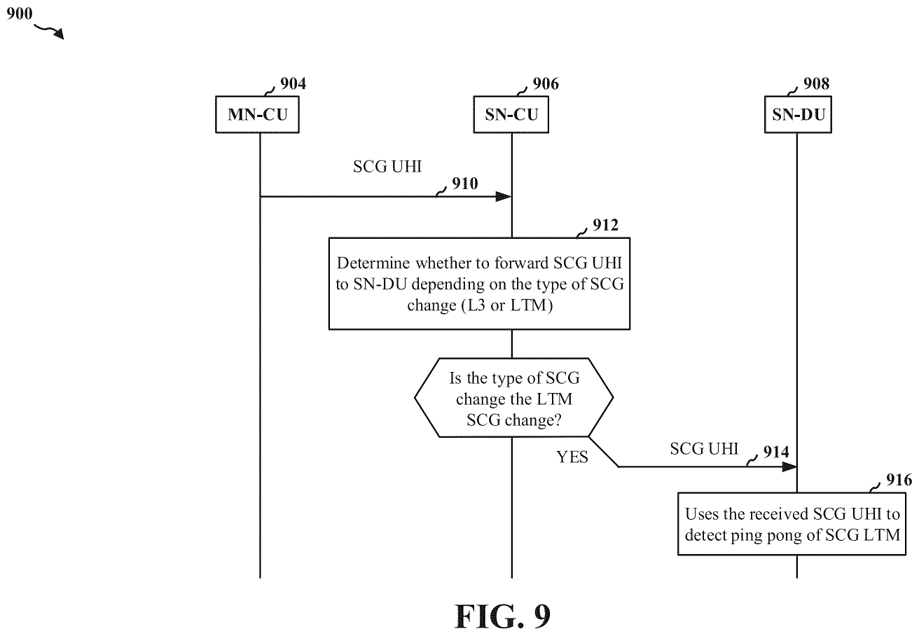

In some aspects, the enhancements to the F1 interface communication may further include the SN-CU forwarding SCG UE history information (SCG UHI) to the SN-DU. In some examples, the SCG UHI may include the type of SCG change, indicating whether the SCG change was based on L3-based SCG change or LTM-based SCG change. FIG. 9 is a diagram 900 illustrating example enhancements for the F1 interface communication in accordance with various aspects of the present disclosure. As shown in FIG. 9, when the SN-CU 906 receives the SCG UHI, which may include the type of SCG change, from the MN-CU 904 at 910, the SN-CU 906 may, at 912, determine whether or not to forward the SCG UHI to the SN-DU 908 based on the type of SCG failure (e.g., whether the SCG change is based on L3 or LTM). In some examples, if the SN-CU 906 determines (e.g., at 912) that the SCG change is an LTM-based SCG change, the SN-CU 906 may, at 914, forward the SCG UHI to the SN-DU 908. The SN-DU 908 may, at 916, use the received SCG UHI to, for example, detect occurrences of ping-pong behavior in SCG LTM procedures (e.g., frequent and rapid switching of the SCG due to, for example, fluctuating network conditions).

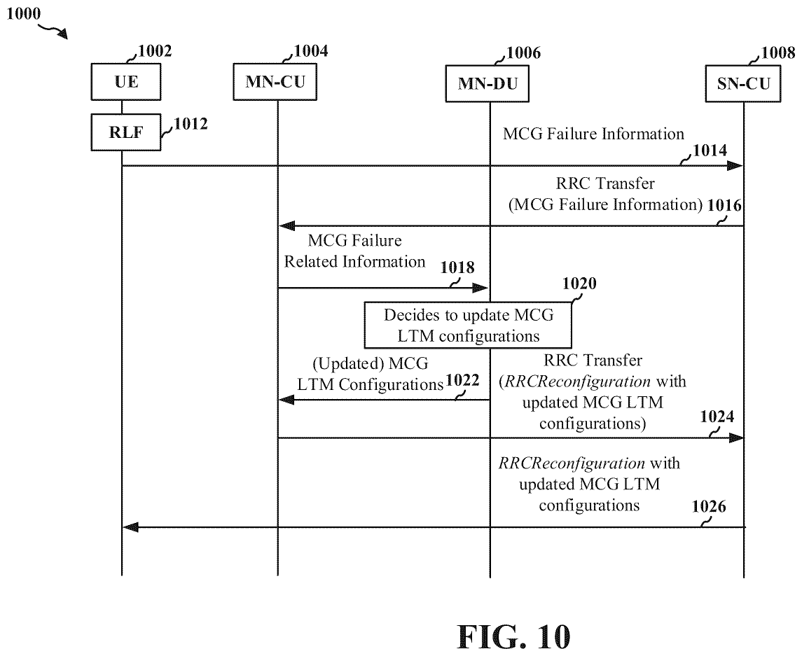

In some aspects, the enhancements to the F1 interface communication may include updates to the MCG LTM configuration, for example, during fast MCG recovery. FIG. 10 is a diagram 1000 illustrating example enhancements for the F1 interface communication in accordance with various aspects of the present disclosure. As shown in FIG. 10, a UE (e.g., UE 1002) may be configured with an MCG LTM configuration and may also be configured to perform LTM recovery. In some examples, the UE (e.g., UE 1002) may encounter a radio link failure (RLF) at 1012 before being able to execute the MCG LTM procedure. In this case, the UE 1002 may, at 1014, send MCG failure information (e.g., via MCGFailureInformation message) to SN-CU 1008, which may, at 1016, forward the MCG failure information to MN-CU 1004.

As shown in FIG. 10, upon receiving the MCG failure information (e.g., MCGFailureInformation message) from the SN-CU 1008, the MN-CU 1004 may, at 1018, forward this MCG failure information, along with other relevant MCG failure-related data, to the MN-DU 1006. Based on this information, during fast recovery (e.g., based on the most recent L1 or L3 measurements in the MCGFailureInformation message), the MN-DU 1006 may, at 1020, determine whether an update to the MCG LTM configuration is necessary. In some examples, the MN-DU 1006 may determine to update the MCG LTM configuration and, at 1022, send the updated MCG LTM configurations to the MN-CU 1014. In some examples, the MN-CU 1004 may, at 1024, forward these updated MCG LTM configurations to the SN-CU 1008, which in turn may, at 1026, send the updated MCG LTM configurations to the UE 1002.

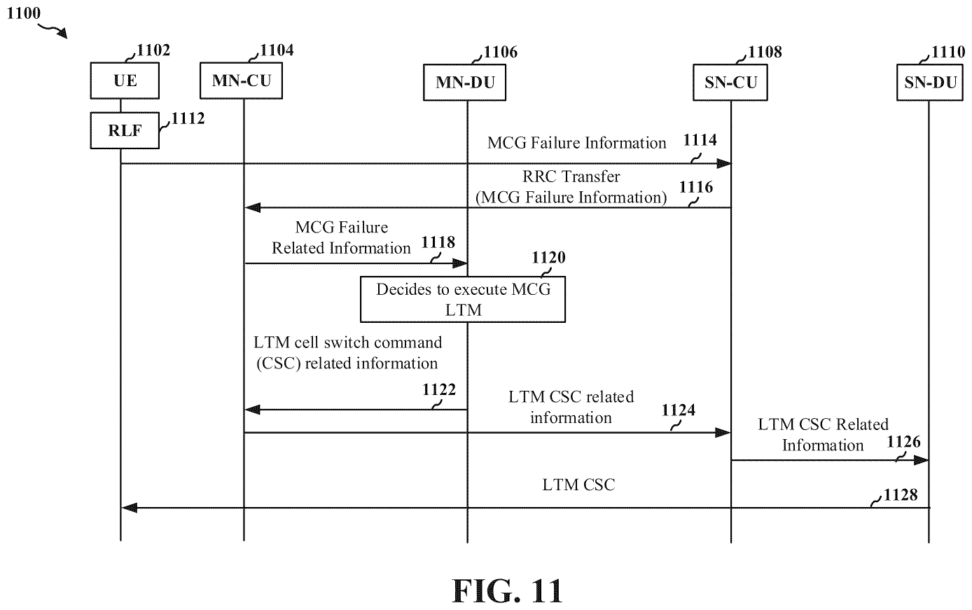

In some aspects, the enhancements to the F1 interface communication may include the transmission of MCG LTM CSC via the SN during fast MCG recovery. FIG. 11 is a diagram 1100 illustrating example enhancements for the F1 interface communication in accordance with various aspects of the present disclosure. As shown in FIG. 11, in some examples, a UE (e.g., UE 1102) may be configured with MCG LTM configuration but is not configured to perform LTM recovery. In some examples, the UE (e.g., UE 1102) may encounter an RLF at 1112 before being able to execute the MCG LTM procedure. In this case, the UE 1102 may, at 1114, send MCG failure information (e.g., via MCGFailureInformation message) to SN-CU 1108, which may, at 1116, forward the MCG failure information to MN-CU 1104. Upon receiving the MCG failure information (e.g., MCGFailureInformation message) from the SN-CU 1108, the MN-CU 1104 may, at 1118, forward this MCG failure information, along with other relevant MCG failure-related data, to the MN-DU 1106.

In some examples, if LTM recovery is not configured, the UE (e.g., UE 1102) may need to perform a reestablishment procedure upon encountering RLF (e.g., at 1112). As a result, the MCG LTM configurations previously stored in the UE (e.g., UE 1102) for subsequent LTM may not be used, leading to increased latency associated with the reestablishment process.

To address this limitation, in some aspects, during fast MCG recovery, the MN-DU (e.g., MN-DU 1106) may, at 1120, decide to perform MCG LTM and generate the necessary details to be included in the MCG LTM cell switch command (CSC). The MCG LTM CSC then may be forwarded to the SN-DU 1110 through the following path: from the MN-DU 1106 to the MN-CU 1104 (e.g., via 1122), then to the SN-CU 1108 (e.g., via 1124), and to the SN-DU 1110 (e.g., via 1126).

Once the SN-DU 1110 receives the MCG LTM CSC, it may, at 1128, transmit the LTM CSC MAC-control element (MAC-CE) to the UE 1102. Upon receiving the LTM CSC MAC-CE, the UE 1102 may perform the MCG LTM.

Some example aspects provide enhancements for Xn interface communication between the master node and the secondary node. In some aspects, the enhancements to the Xn interface communication may include improved coordination between the SN and the MN regarding SCG LTM configurations. For example, the improved coordination between the SN and the MN regarding SCG LTM configuration may support the co-existence of MCG LTM configurations and SCG LTM configurations, while ensuring that they are not executed simultaneously.

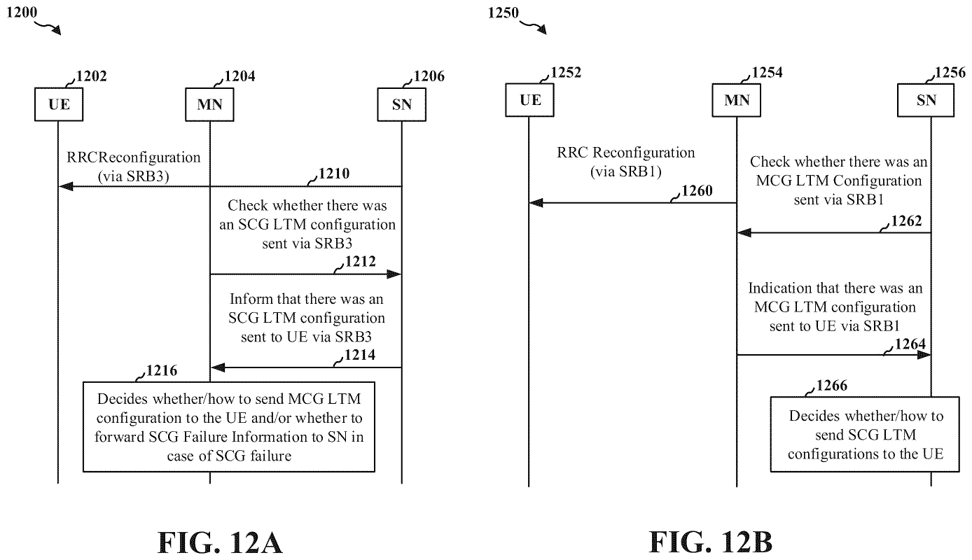

FIG. 12A is a diagram 1200 illustrating example enhancements for the Xn interface communication in accordance with various aspects of the present disclosure. As shown in FIG. 12A, to support the co-existence of MCG LTM configurations and SCG LTM configurations, the SN 1206 may, at 1214, inform the MN 1204, for example, through an SN Modification Required message, whenever an SCG LTM configuration is sent (e.g., to UE 1202 via 1210) or released via SRB3, meaning it occurs without the direct involvement of the MN 1204. This notification (e.g., at 1214) allows the MN 1204 to remain aware of SCG LTM activities even if the MN 1204 did not initiate or process them directly. For example, based on the information provided by the SN 1206 at 1214, the MN 1204 may, at 1216, decide whether or how to send MCG LTM configuration to the UE (e.g., UE 1202) or whether to forward SCG failure information to SN (e.g., SN 1206) in case of SCG failure.

In some examples, the information provided by the SN 1206 to the MN 1204 may take the form of a simple flag indicating that an SCG LTM configuration was sent, or it may include more detailed content. These details may include the complete SCG LTM configuration that was transmitted to the UE (e.g., UE 1202), or a subset of the SCG LTM configuration, such as the list of SCG LTM candidate cells.

In some examples, the MN 1204 may, at 1212, send an inquiry to the SN 1206 to check whether an SCG LTM configuration was transmitted via the SRB3. The SN 1206 may inform the MN 1204 whether an SCG LTM configuration has been sent or released via SRB3 in response to the inquiry from the MN 1204 at 1212.

FIG. 12B is a diagram 1250 illustrating example enhancements for the Xn interface communication in accordance with various aspects of the present disclosure. As shown in FIG. 12B, to support the co-existence of MCG LTM configurations and SCG LTM configurations, the MN 1254 may, at 1264, inform the SN 1256, for example, through an SN Modification Request message, whenever an MCG LTM configuration is sent or released (e.g., to UE 1252 via 1260) via SRB1, meaning it occurs without the direct involvement of the SN 1256. This notification (e.g., at 1264) allows the SN 1256 to remain aware of MCG LTM activities even if the SN 1256 did not initiate or process them directly. For example, based on the information provided by the MN 1254 at 1264, the SN 1256 may, at 1266, decide whether or how to send SCG LTM configuration to the UE (e.g., UE 1252).

In some examples, the information provided by the MN 1254 to the SN 1256 may take the form of a simple flag indicating that an MCG LTM configuration was sent to the UE, or it may include more detailed content. These details may include the complete MCG LTM configuration that was transmitted to the UE (e.g., UE 1252), or a subset of the MCG LTM configuration, such as the list of MCG LTM candidate cells.

In some examples, the SN 1256 may, at 1262, send an inquiry to the MN 1254 to check whether an MCG LTM configuration was transmitted or released to the UE via the SRB1. The MN 1254 may inform the SN 1256 whether an MCG LTM configuration has been sent or released to UE 1252 in response to the inquiry from the SN 1256 at 1262.

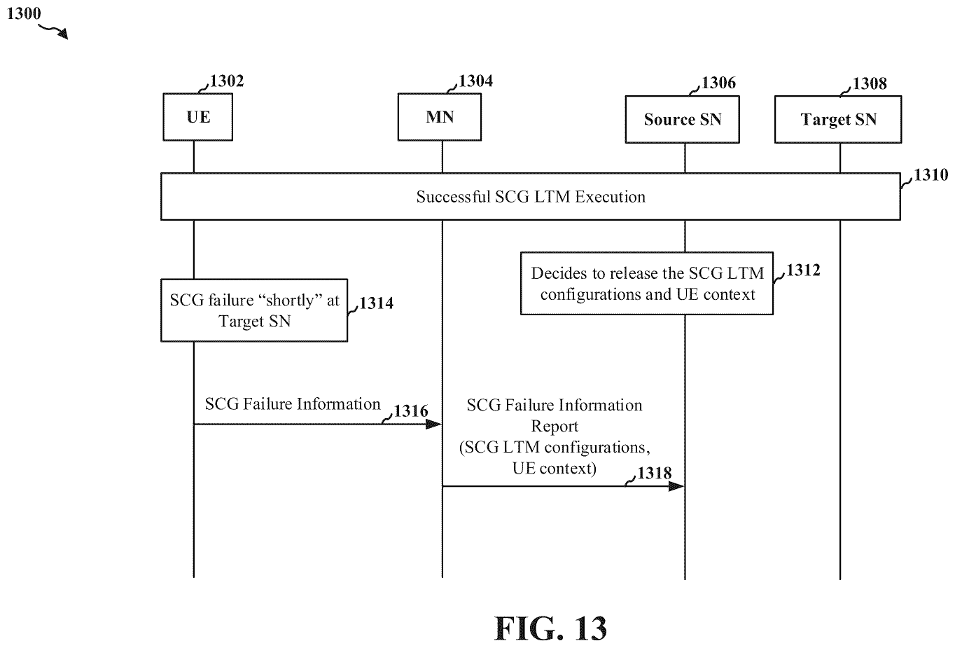

FIG. 13 is a diagram 1300 illustrating example enhancements for the Xn interface communication in accordance with various aspects of the present disclosure. As shown in FIG. 13, in some examples, after a successful SCG LTM execution (e.g., at 1310), the source SN 1306 may retain the SCG LTM configuration to support any subsequent SCG LTM procedures. However, certain situations may arise where the source SN 1306 may decide to release the SCG, LTM configurations (e.g., at 1312), such as in case of resource shortages. If an SCG failure occurs (e.g., at 1314) shortly after the SCG LTM configuration has been released (e.g., at 1312), the source SN may no longer be capable of performing proper optimization of the SCG LTM failure, even upon receiving the existing SCG failure information report from the MN (e.g., MN 1304). FIG. 13 also shows source SN 1306 in association with target SN 1308.

To address this limitation, example aspects provide enhancements to the Xn interface communication (e.g., communication between the MN 1304 and the SN (e.g., source SN 1306)) that involve the MN (e.g., MN 1304) assisting the SN (e.g., source SN 1306) with UE context information and SCG LTM configuration.

As shown in FIG. 13, the MN 1304 may assist the source SN 1306 by, at 1318, forwarding any stored SCG LTM configurations and relevant UE context when sending the SCG failure information report.

For example, in additional to the SCG failure information received from UE 1302 at 1316, the forwarded information may further include elements such as the LTM or conditional LTM (C-LTM) configuration, which may include, for example, the list of LTM candidate cells, candidate cell IDs, and the C-LTM execution conditions such as report configuration and MeasObject containers. In some examples, the forwarded information may further include L1 reference signal (RS) configuration and any early uplink or downlink synchronization configurations.

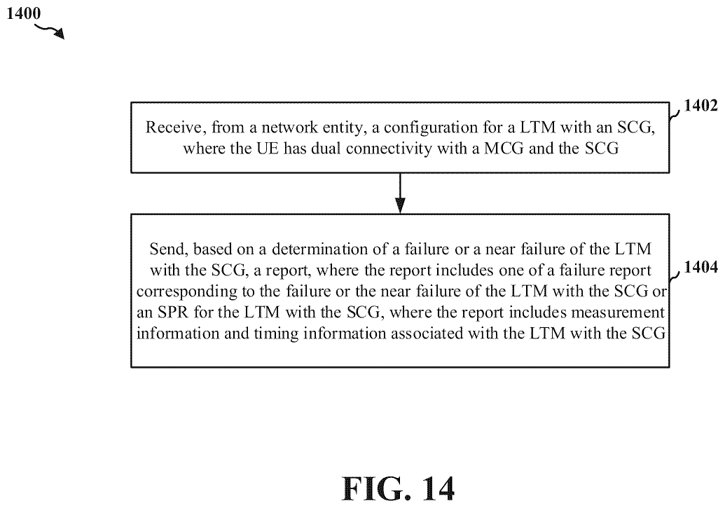

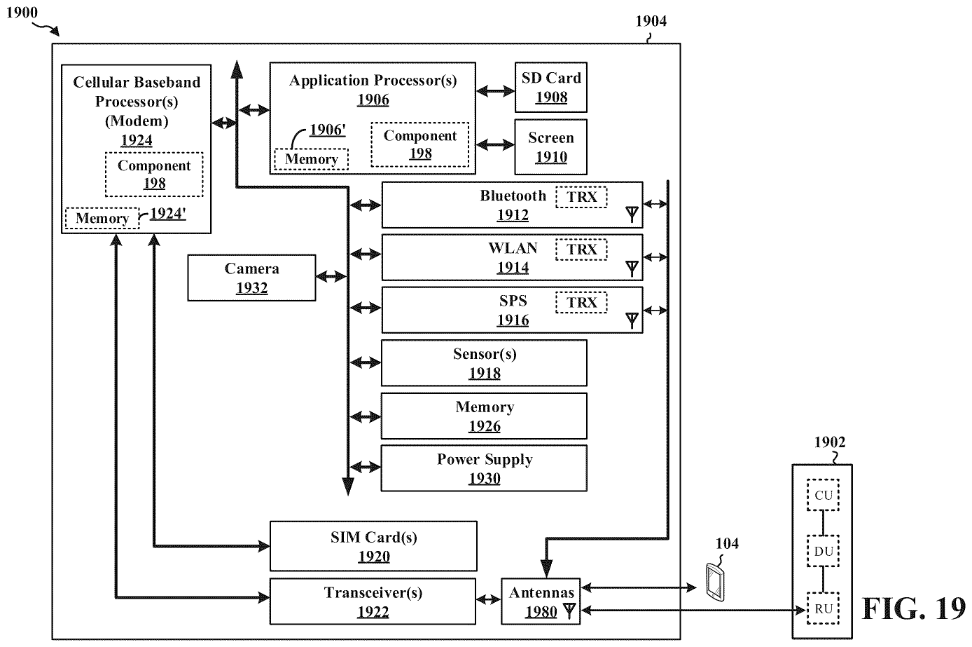

FIG. 14 is a flowchart 1400 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310; or the network entity 1902 in the hardware implementation of FIG. 19). The network entity may include or be associated with an MN and an SN. For example, the MN may be MN 704, 754, 1204, 1254, 1304, MN-CU 804, 904, 1004, 1104, 1004, MN-DU 1006, 1106. The SN may be SN 706, 1206, 1256, source SN 1306, SN-CU 756, 806, 906, 1008, 1108, SN-DU 758, 808, 908, 1110. The UE may be the UE 104, 350, 502, 602, 702, 752, 802, 1002, 1102, 1202, 1252, 1302 or the apparatus 1904 in the hardware implementation of FIG. 19. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

As shown in FIG. 14, at 1402, the UE may receive, from a network entity, a configuration for an LTM with an SCG. The UE may have dual connectivity with an MCG and the SCG. FIG. 7A, FIG. 7B, FIG. 8, FIG. 9, FIG. 10, FIG. 11, FIG. 12A, FIG. 12B, and FIG. 13 illustrate various aspects of the steps in connection with flowchart 1400. For example, referring to FIG. 7A, the UE 702 may, at 710, receive, from a network entity (e.g., SN 706), a configuration for an LTM with an SCG (e.g., RRCReconfiguration message). The UE 702 may have dual connectivity with an MCG (e.g., MN 704) and the SCG (e.g., SN 706). For example, the UE may be UE 602, the MCG may be MCG 604, and the SCG may be SCG 606. In some aspects, 1402 may be performed by the SCG LTM component 198.

At 1404, the UE may send, based on the determination of a failure or a near failure of the LTM with the SCG, a report. The report may include one of a failure report corresponding to the failure or the near failure of the LTM with the SCG or a successful primary serving cell (PSCell) change report (SPR) for the LTM with the SCG. The report may include measurement information and timing information associated with the LTM with the SCG. For example, referring to FIG. 7A, the UE 702 may, at 712 send, based on the determination of a failure or a near failure of the LTM with the SCG (e.g., SN 706), a report. The report may include one of a failure report (e.g., SCG failure information at 712) corresponding to the failure or the near failure of the LTM with the SCG or an SPR (e.g., SPR at 776) for the LTM with the SCG. The report may include measurement information and timing information associated with the LTM with the SCG. In some aspects, 1404 may be performed by the SCG LTM component 198.

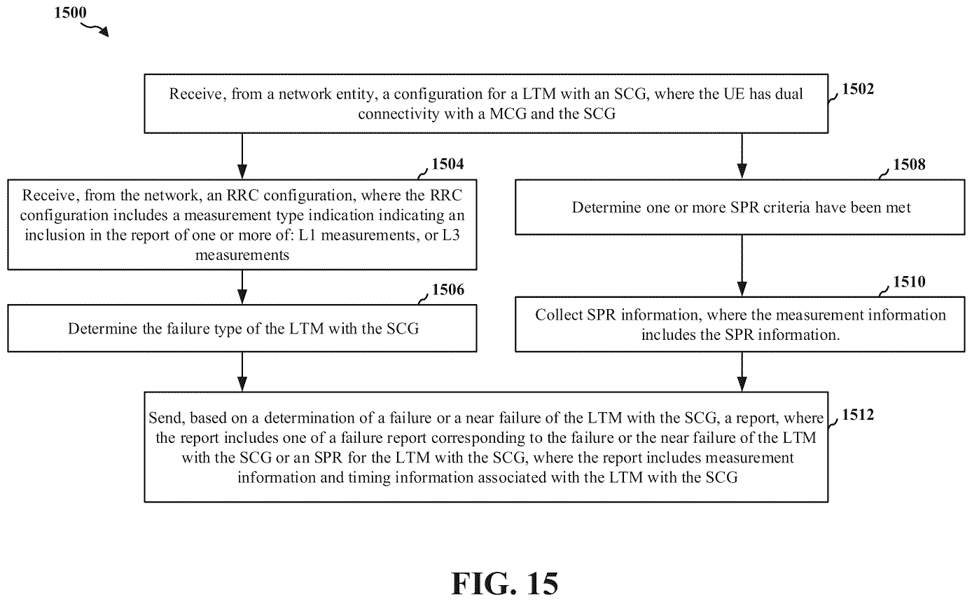

FIG. 15 is a flowchart 1500 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310; or the network entity 1902 in the hardware implementation of FIG. 19). The network entity may include or be associated with an MN and an SN. For example, the MN may be MN 704, 754, 1204, 1254, 1304, MN-CU 804, 904, 1004, 1104, 1004, MN-DU 1006, 1106. The SN may be SN 706, 1206, 1256, source SN 1306, SN-CU 756, 806, 906, 1008, 1108, SN-DU 758, 808, 908, 1110. The UE may be the UE 104, 350, 502, 602, 702, 752, 802, 1002, 1102, 1202, 1252, 1302 or the apparatus 1904 in the hardware implementation of FIG. 19. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

As shown in FIG. 15, at 1502, the UE may receive, from a network entity, a configuration for an LTM with an SCG. The UE may have dual connectivity with an MCG and the SCG. FIG. 7A, FIG. 7B, FIG. 8, FIG. 9, FIG. 10, FIG. 11, FIG. 12A, FIG. 12B, and FIG. 13 illustrate various aspects of the steps in connection with flowchart 1500. For example, referring to FIG. 7A, the UE 702 may, at 710, receive, from a network entity (e.g., SN 706), a configuration for an LTM with an SCG (e.g., RRCReconfiguration message). The UE 702 may have dual connectivity with an MCG (e.g., MN 704) and the SCG (e.g., SN 706). For example, the UE may be UE 602, the MCG may be MCG 604, and the SCG may be SCG 606. In some aspects, 1502 may be performed by the SCG LTM component 198.

At 1512, the UE may send, based on the determination of a failure or a near failure of the LTM with the SCG, a report. The report may include one of a failure report corresponding to the failure or the near failure of the LTM with the SCG or a successful primary serving cell (PSCell) change report (SPR) for the LTM with the SCG. The report may include measurement information and timing information associated with the LTM with the SCG. For example, referring to FIG. 7A, the UE 702 may, at 712 send, based on the determination of a failure or a near failure of the LTM with the SCG (e.g., SN 706), a report. The report may include one of a failure report (e.g., SCG failure information at 712) corresponding to the failure or the near failure of the LTM with the SCG or an SPR (e.g., SPR at 776) for the LTM with the SCG. The report may include measurement information and timing information associated with the LTM with the SCG. In some aspects, 1512 may be performed by the SCG LTM component 198.

In some aspects, the report may include the failure report. In this case, the UE may, at 1506, determine the failure type of the LTM with the SCG. The failure type may be based on one of: a delay in the execution of an SCG LTM based on a first timer, an early execution of the SCG LTM, or the execution of the SCG LTM to a wrong PSCell based on at least a second timer, where the second timer represents a time elapsed since the execution of the SCG LTM until an SCG failure. In some aspects, 1506 may be performed by the SCG LTM component 198.

In some aspects, the measurement information associated with the LTM with the SCG may include one or more of: layer 1 (L1) or layer 3 (L3) measurements for a serving PSCell or a target PSCell, the L1 or L3 measurements for one or more neighboring PSCells, or the L1 or L3 measurements for one or more LTM candidate PSCells. In some aspects, the timing information associated with the LTM with the SCG may include one or more of: a timer, or a timing advance (TA) acquisition type for the LTM with the SCG. For example, referring to FIG. 7A, the measurement information associated with the LTM with the SCG (e.g., SCG failure information at 712) may include one or more of: L1 or L3 measurements for a serving PSCell or a target PSCell, the L1 or L3 measurements for one or more neighboring PSCells, or the L1 or L3 measurements for one or more LTM candidate PSCells. In some aspects, the timing information associated with the LTM with the SCG (e.g., the timing information in SCG failure information at 712) may include one or more of: a timer, or the TA acquisition type for the LTM with the SCG.

In some aspects, the TA acquisition type may include one of: a network-provided TA, or a UE-based TA. For example, referring to FIG. 7A, the TA acquisition type (e.g., in the SCG failure information at 712) may include one of: a network-provided TA, or a UE-based TA.

In some aspects, the report may further include one or more of: a first indication that the UE was configured with the configuration for the LTM with the SCG before the SCG failure, a second indication of whether each neighboring PSCell of the one or more neighboring PSCells is an LTM candidate cell, or a set of LTM candidate PSCells of the UE. For example, referring to FIG. 7A, the report (e.g., the SCG failure information at 712) may further include one or more of: a first indication that the UE (e.g., UE 702) was configured with the configuration for the LTM with the SCG before the SCG failure, a second indication of whether each neighboring PSCell of the one or more neighboring PSCells is an LTM candidate cell, or a set of LTM candidate PSCells of the UE (e.g., UE 702).

In some aspects, at 1504, the UE may receive, from the network entity, a radio resource control (RRC) configuration. The RRC configuration may include a measurement type indication indicating an inclusion in the report of one or more of: L1 measurements, or L3 measurements. The measurement information included in the report may be based on the measurement type indication. For example, referring to FIG. 7A, the UE 702 may, at 710, receive, from the network entity (e.g., SN 706), an RRC configuration (e.g., RRCReconfiguration message). The RRC configuration (e.g., RRCReconfiguration message) may include a measurement type indication indicating an inclusion in the report (e.g., SCG failure information at 712) of one or more of: L1 measurements, or L3 measurements. The measurement information included in the report may be based on the measurement type indication.

In some aspects, the report may include the SPR for the LTM with the SCG. In this case, the UE may, at 1508, determine one or more SPR criteria have been met; and, at 1510, collect SPR information. The measurement information may include the SPR information. For example, referring to FIG. 7B, the report may include the SPR (e.g., SPR at 776) for the LTM with the SCG. In this case, the UE (e.g., UE 752) may, at 774, determine one or more SPR criteria have been met and collect SPR information. The measurement information may include the SPR information. In some aspects, 1508 and 1510 may be performed by the SCG LTM component 198.

In some aspects, the configuration for the LTM with the SCG may include one or more SPR thresholds, and the one or more SPR thresholds may be configured by a DU of a secondary node. The one or more SPR criteria may be based on the one or more SPR thresholds. For example, referring to FIG. 7B, the configuration for the LTM with the SCG (e.g., the SCG LTM configuration at 772) may include one or more SPR thresholds, and the one or more SPR thresholds may be configured by a DU of a secondary node (e.g., SN-DU 758). The one or more SPR criteria may be based on the one or more SPR thresholds.

In some aspects, the configuration for the LTM with the SCG may include initiating node information, and the initiating node information may include one of a master node or a secondary node as an initiating node. For example, referring to FIG. 7B, the configuration for the LTM with the SCG (e.g., SCG LTM configuration at 772) may include initiating node information, and the initiating node information may include one of a master node (e.g., MN 754) or a secondary node as an initiating node. In some aspects, the SPR may include one or more of: the initiating node for the SCG LTM, the type of PSCell change, L1 measurements, L3 measurements, or a timer representing the time elapsed since an execution of the SCG LTM until an SCG failure. For example, referring to FIG. 7B, the SPR (e.g., the SPR at 776) may include one or more of: the initiating node for the SCG LTM (e.g., MN or SN), the type of PSCell change (e.g., L3-based PSCell change or LTM-based PSCell change), L1 measurements, L3 measurements, or a timer representing the time elapsed since an execution of the SCG LTM until an SCG failure.

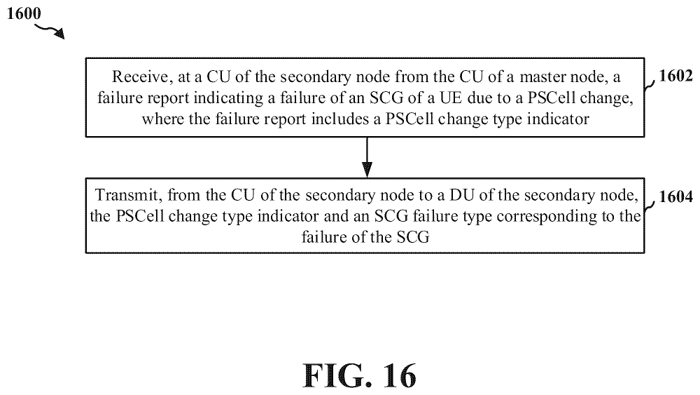

FIG. 16 is a flowchart 1600 illustrating methods of wireless communication at a secondary node of a network entity in accordance with various aspects of the present disclosure. The method may be performed by the network entity in collaboration with a UE. The network entity may be a base station, or a component of a base station, in the access network of FIG. 1 or a core network component (e.g., base station 102, 310; or the network entity 1902 in the hardware implementation of FIG. 19). The secondary node may be SN 706, 1206, 1256, source SN 1306, SN-CU 756, 806, 906, 1008, 1108, SN-DU 758, 808, 908, 1110. The network entity may further include or be associated with a master node. The master node may be MN 704, 754, 1204, 1254, 1304, MN-CU 804, 904, 1004, 1104, 1004, MN-DU 1006, 1106. The UE may be the UE 104, 350, 502, 602, 702, 752, 802, 1002, 1102, 1202, 1252, 1302 or the apparatus 1904 in the hardware implementation of FIG. 19. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

As shown in FIG. 16, at 1602, the CU of the secondary node may receive, from the CU of a master node, a failure report indicating a failure of an SCG of a UE due to a PSCell change. The failure report may include a PSCell change type indicator. FIG. 7A, FIG. 7B, FIG. 8, FIG. 9, FIG. 10, FIG. 11, FIG. 12A, FIG. 12B, and FIG. 13 illustrate various aspects of the steps in connection with flowchart 1600. For example, referring to FIG. 8, the CU of the secondary node (e.g., SN-CU 806) may, at 812, receive, from the CU of a master node (e.g., MN-CU 804), a failure report (e.g., SCG failure information report) indicating a failure of an SCG of a UE (e.g., UE 802) due to a PSCell change. The failure report may include a PSCell change type indicator. In some aspects, 1602 may be performed by the SCG LTM component 199.

At 1604, the CU of the secondary node may transmit, to a DU of the secondary node, the PSCell change type indicator and an SCG failure type corresponding to the failure of the SCG. For example, referring to FIG. 8, the CU of the secondary node (e.g., SN-CU 806) may, at 816, transmit, to a DU of the secondary node (e.g., SN-DU 808), the PSCell change type indicator and an SCG failure type corresponding to the failure of the SCG. In some aspects, 1604 may be performed by SCG LTM component 199.

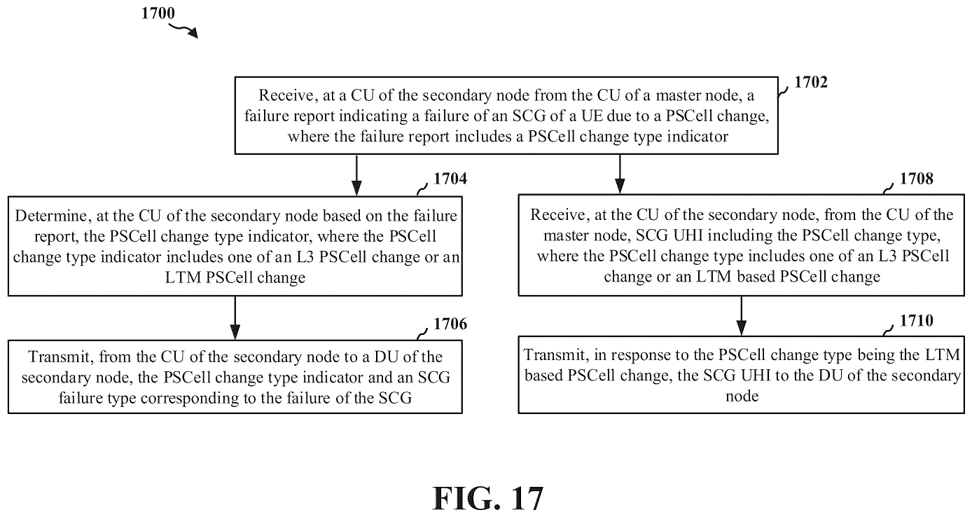

FIG. 17 is a flowchart 1700 illustrating methods of wireless communication at a secondary node of a network entity in accordance with various aspects of the present disclosure. The method may be performed by the network entity in collaboration with a UE. The network entity may be a base station, or a component of a base station, in the access network of FIG. 1 or a core network component (e.g., base station 102, 310; or the network entity 1902 in the hardware implementation of FIG. 19). The secondary node may be SN 706, 1206, 1256, source SN 1306, SN-CU 756, 806, 906, 1008, 1108, SN-DU 758, 808, 908, 1110. The network entity may further include or be associated with a master node. The master node may be MN 704, 754, 1204, 1254, 1304, MN-CU 804, 904, 1004, 1104, 1004, MN-DU 1006, 1106. The UE may be the UE 104, 350, 502, 602, 702, 752, 802, 1002, 1102, 1202, 1252, 1302 or the apparatus 1904 in the hardware implementation of FIG. 19. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

As shown in FIG. 17, at 1702, the CU of the secondary node may receive, from the CU of a master node, a failure report indicating a failure of an SCG of a UE due to a PSCell change. The failure report may include a PSCell change type indicator. FIG. 7A, FIG. 7B, FIG. 8, FIG. 9, FIG. 10, FIG. 11, FIG. 12A, FIG. 12B, and FIG. 13 illustrate various aspects of the steps in connection with flowchart 1700. For example, referring to FIG. 8, the CU of the secondary node (e.g., SN-CU 806) may, at 812, receive, from the CU of a master node (e.g., MN-CU 804), a failure report (e.g., SCG failure information report) indicating a failure of an SCG of a UE (e.g., UE 802) due to a PSCell change. The failure report may include a PSCell change type indicator. In some aspects, 1702 may be performed by the SCG LTM component 199.

At 1706, the CU of the secondary node may transmit, to a DU of the secondary node, the PSCell change type indicator and an SCG failure type corresponding to the failure of the SCG. For example, referring to FIG. 8, the CU of the secondary node (e.g., SN-CU 806) may, at 816, transmit, to a DU of the secondary node (e.g., SN-DU 808), the PSCell change type indicator and an SCG failure type corresponding to the failure of the SCG. In some aspects, 1706 may be performed by SCG LTM component 199.

In some aspects, the CU of the secondary node may, at 1704, determine, based on the failure report, the PSCell change type indicator. The PSCell change type indicator may include one of an L3 PSCell change or an LTM PSCell change. For example, referring to FIG. 8, the CU of the secondary node (e.g., SN-CU 806) may, at 814, determine, based on the failure report (e.g., SCG failure information report at 812), the PSCell change type indicator. The PSCell change type indicator may include one of an L3 PSCell change or an LTM PSCell change. In some aspects, 1704 may be performed by SCG LTM component 199.

In some aspects, the SCG failure type may indicate one of: a delay in the execution of an SCG LTM, an early execution of the SCG LTM, or the execution of the SCG LTM to a wrong PSCell based on a timer, where the timer represents the time elapsed since the execution of the SCG LTM until an SCG failure. For example, referring to FIG. 8, the SCG failure type (e.g., at 816) may indicate one of: a delay in the execution of an SCG LTM, an early execution of the SCG LTM, or the execution of the SCG LTM to a wrong PSCell based on a timer, where the timer represents the time elapsed since the execution of the SCG LTM until an SCG failure.

In some aspects, the CU of the secondary node may, at 1708, receive, from the CU of the master node, SCG UE history information (UHI) including the PSCell change type. The PSCell change type may include one of an L3 PSCell change or an LTM based PSCell change. The CU of the secondary node may further, at 1710, transmit, in response to the PSCell change type being the LTM based PSCell change, the SCG UHI to the DU of the secondary node. For example, referring to FIG. 9, the CU of the secondary node (e.g., SN-CU 906) may, at 910, receive, from the CU of the master node (e.g., MN-CU 904), SCG UHI including the PSCell change type. The PSCell change type may include one of an L3 PSCell change or an LTM based PSCell change. The CU of the secondary node (e.g., SN-CU 906) may further, at 914, transmit, in response to the PSCell change type being the LTM based PSCell change, the SCG UHI to the DU of the secondary node (e.g., SN-DU 908). In some aspects, 1708 and 1710 may be performed by SCG LTM component 199.

In some aspects, the secondary node may be a source secondary node in a successful SCG LTM execution prior to the reception of the failure report indicating the failure of the SCG of the UE, and the failure report may further include one or more of: one or more LTM configurations, UE context information, an L1 reference signal configuration, or an early uplink or downlink synchronization configuration. For example, referring to FIG. 13, the secondary node may be a source secondary node (e.g., source SN 1306) in a successful SCG LTM execution (e.g., at 1310) prior to the reception (e.g., at 1318) of the failure report (e.g., SCG failure information report) indicating the failure of the SCG of the UE (e.g., UE 1302), and the failure report (e.g., SCG failure information report at 1318) may further include one or more of: one or more LTM configurations, UE context information, an L1 reference signal configuration, or an early uplink or downlink synchronization configuration.

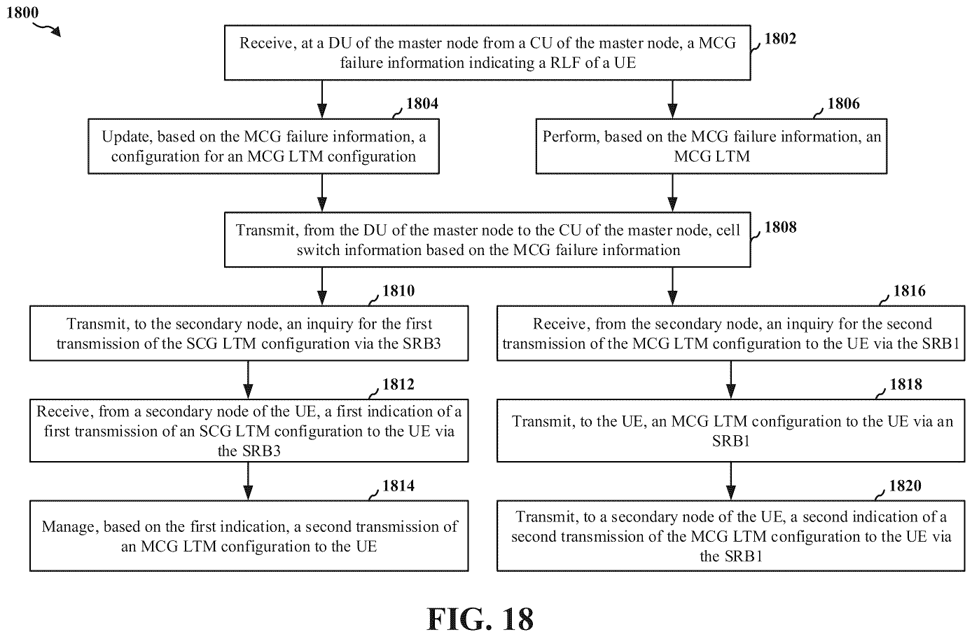

FIG. 18 is a flowchart 1800 illustrating methods of wireless communication at a master node of a network entity in accordance with various aspects of the present disclosure. The method may be performed by a network entity in collaboration with a UE. The network entity may be a base station, or a component of a base station, in the access network of FIG. 1 or a core network component (e.g., base station 102, 310; or the network entity 1902 in the hardware implementation of FIG. 19). The master node may be MN 704, 754, 1204, 1254, 1304, MN-CU 804, 904, 1004, 1104, 1004, MN-DU 1006, 1106. In some examples, the network entity may include or be associated with a secondary node. The secondary node may be SN 706, 1206, 1256, source SN 1306, SN-CU 756, 806, 906, 1008, 1108, SN-DU 758, 808, 908, 1110. The UE may be the UE 104, 350, 502, 602, 702, 752, 802, 1002, 1102, 1202, 1252, 1302 or the apparatus 1904 in the hardware implementation of FIG. 19. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

As shown in FIG. 18, at 1802, the DU of the master node may receive, from a CU of the master node, an MCG failure information indicating a radio link failure (RLF) of a UE. FIG. 7A, FIG. 7B, FIG. 8, FIG. 9, FIG. 10, FIG. 11, FIG. 12A, FIG. 12B, and FIG. 13 illustrate various aspects of the steps in connection with flowchart 1800. For example, referring to FIG. 10, the DU of the master node (e.g., MN-DU 1006) may, at 1018, receive, from a CU of the master node (e.g., MN-CU 1004), an MCG failure information indicating an RLF of a UE (e.g., RLF at 1012 for UE 1002). In some aspects, 1802 may be performed by the SCG LTM component 199.

In some aspects, at 1808, the DU of the master node may transmit, to the CU of the master node, cell switch information based on the MCG failure information. For example, referring to FIG. 11, the DU of the master node (e.g., MN-DU 1106) may, at 1122, transmit, to the CU of the master node (e.g., MN-CU 1104), cell switch information based on the MCG failure information (e.g., received at 1118). In some aspects, 1808 may be performed by the SCG LTM component 199.

In some aspects, the DU of the master node may, at 1804, update, based on the MCG failure information, a configuration for an MCG LTM configuration for the UE to obtain an updated MCG LTM configuration, and the cell switch information may include the updated MCG LTM configuration. For example, referring to FIG. 10, the DU of the master node (e.g., MN-DU 1006) may, at 1020, update, based on the MCG failure information, a configuration for an MCG LTM configuration for the UE to obtain an updated MCG LTM configuration, and the cell switch information may include the updated MCG LTM configuration. In some aspects, 1804 may be performed by the SCG LTM component 199.

In some aspects, the DU of the master node may, at 1806, perform, based on the MCG failure information, an MCG LTM. For example, referring to FIG. 11, the DU of the master node (e.g., MN-DU 1106) may, at 1120, perform, based on the MCG failure information (e.g., received at 1118), an MCG LTM. In some aspects, 1806 may be performed by the SCG LTM component 199.

In some aspects, the cell switch information may include LTM cell switch command (CSC) information. For example, referring to FIG. 11, the cell switch information (e.g., at 1122) may include LTM CSC information.

In some aspects, at 1812, the master node may receive, from a secondary node of the UE, a first indication of a first transmission of an SCG LTM configuration to the UE via the SRB3. At 1814, the master node may manage, based on the first indication, the second transmission of an MCG LTM configuration to the UE. For example, referring to FIG. 12A, the master node (e.g., MN 1204) may, at 1214, receive, from a secondary node (e.g., SN 1206) of the UE, a first indication of a first transmission of an SCG LTM configuration to the UE via the SRB3. At 1216, the master node (e.g., MN 1204) may manage, based on the first indication, the second transmission of an MCG LTM configuration to the UE. In some aspects, 1812 and 1814 may be performed by the SCG LTM component 199.

In some aspects, the master node may, at 1810, transmit, to the secondary node, an inquiry for the first transmission of the SCG LTM configuration via the SRB3. The reception of the first indication (e.g., at 1812) may be based on the inquiry. For example, referring to FIG. 12A, the master node (e.g., MN 1204) may, at 1212, transmit, to the secondary node (e.g., SN 1206), an inquiry for the first transmission of the SCG LTM configuration via the SRB3. The reception of the first indication (e.g., at 1214) may be based on the inquiry. In some aspects, 1810 may be performed by the SCG LTM component 199.

In some aspects, the master node may, at 1818, transmit an MCG LTM configuration to the UE via an SRB1, and, at 1820, transmit, to a secondary node of the UE, a second indication of a second transmission of the MCG LTM configuration to the UE via the SRB1. The third transmission of an SCG LTM configuration to the UE may be based on the second indication. For example, referring to FIG. 12B, the master node (e.g., MN 1254) may, at 1260, transmit an MCG LTM configuration to the UE via an SRB1, and, at 1264, transmit, to a secondary node (e.g., SN 1256) of the UE, a second indication of a second transmission of the MCG LTM configuration to the UE via the SRB1. The third transmission of an SCG LTM configuration to the UE may be based on the second indication. In some aspects, 1818 and 1820 may be performed by the SCG LTM component 199.

In some aspects, the master node may, at 1816, receive, from the secondary node, an inquiry for the second transmission of the MCG LTM configuration to the UE via the SRB1. The transmission of the second indication (e.g., at 1820) may be based on the inquiry. For example, referring to FIG. 12B, the master node (e.g., MN 1254) may, at 1262, receive, from the secondary node (e.g., SN 1256), an inquiry for the second transmission of the MCG LTM configuration to the UE via the SRB1. The transmission of the second indication (e.g., at 1264) may be based on the inquiry. In some aspects, 1816 may be performed by the SCG LTM component 199.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include at least one cellular baseband processor (or processing circuitry) 1924 (also referred to as a modem) coupled to one or more transceivers 1922 (e.g., cellular RF transceiver). The cellular baseband processor(s) (or processing circuitry) 1924 may include at least one on-chip memory (or memory circuitry) 1924′. In some aspects, the apparatus 1904 may further include one or more subscriber identity modules (SIM) cards 1920 and at least one application processor (or processing circuitry) 1906 coupled to a secure digital (SD) card 1908 and a screen 1910. The application processor(s) (or processing circuitry) 1906 may include on-chip memory (or memory circuitry) 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor(s) (or processing circuitry) 1924 communicates through the transceiver(s) 1922 via one or more antennas 1980 with the UE 104 and/or with an RU associated with a network entity 1902. The cellular baseband processor(s) (or processing circuitry) 1924 and the application processor(s) (or processing circuitry) 1906 may each include a computer-readable medium/memory (or memory circuitry) 1924′, 1906′, respectively. The additional memory modules 1926 may also be considered a computer-readable medium/memory (or memory circuitry). Each computer-readable medium/memory (or memory circuitry) 1924′, 1906′, 1926 may be non-transitory. The cellular baseband processor(s) (or processing circuitry) 1924 and the application processor(s) (or processing circuitry) 1906 are each responsible for general processing, including the execution of software stored on the computer-readable medium/memory (or memory circuitry). The software, when executed by the cellular baseband processor(s) (or processing circuitry) 1924/application processor(s) (or processing circuitry) 1906, causes the cellular baseband processor(s) (or processing circuitry) 1924/application processor(s) (or processing circuitry) 1906 to perform the various functions described supra. The cellular baseband processor(s) (or processing circuitry) 1924 and the application processor(s) (or processing circuitry) 1906 are configured to perform the various functions described supra based at least in part of the information stored in the memory (or memory circuitry). That is, the cellular baseband processor(s) (or processing circuitry) 1924 and the application processor(s) (or processing circuitry) 1906 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1924/application processor(s) (or processing circuitry) 1906 when executing software. The cellular baseband processor(s) (or processing circuitry) 1924/application processor(s) (or processing circuitry) 1906 may be a component of the UE 350 and may include the at least one memory 360 and/or at least one of the TX processor 368, the RX processor 356, and the controller/processor 359. In one configuration, the apparatus 1904 may be at least one processor chip (modem and/or application) and include just the cellular baseband processor(s) (or processing circuitry) 1924 and/or the application processor(s) (or processing circuitry) 1906, and in another configuration, the apparatus 1904 may be the entire UE (e.g., see UE 350 of FIG. 3) and include the additional modules of the apparatus 1904.

As discussed supra, the component 198 may be configured to receive, from a network entity, a configuration for an LTM with an SCG, where the UE has dual connectivity with an MCG and the SCG; and send, based on a determination of a failure or a near failure of the LTM with the SCG, a report, where the report includes one of a failure report corresponding to the failure or the near failure of the LTM with the SCG or an SPR for the LTM with the SCG, where the report includes measurement information and timing information associated with the LTM with the SCG. The component 198 may be further configured to perform any of the aspects described in connection with the flowcharts in FIG. 14 and FIG. 15. The component 198 may be within the cellular baseband processor(s) (or processing circuitry) 1924, the application processor(s) (or processing circuitry) 1906, or both the cellular baseband processor(s) (or processing circuitry) 1924 and the application processor(s) (or processing circuitry) 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1904 may include a variety of components configured for various functions. In one configuration, the apparatus 1904, and in particular the cellular baseband processor(s) (or processing circuitry) 1924 and/or the application processor(s) (or processing circuitry) 1906, includes means for receiving, from a network entity, a configuration for an LTM with an SCG, where the UE has dual connectivity with an MCG and the SCG; and means for sending, based on a determination of a failure or a near failure of the LTM with the SCG, a report, where the report includes one of a failure report corresponding to the failure or the near failure of the LTM with the SCG or an SPR for the LTM with the SCG, where the report includes measurement information and timing information associated with the LTM with the SCG. The apparatus 1904 may further include means for performing any of the aspects described in connection with the flowcharts in FIG. 14 and FIG. 15. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

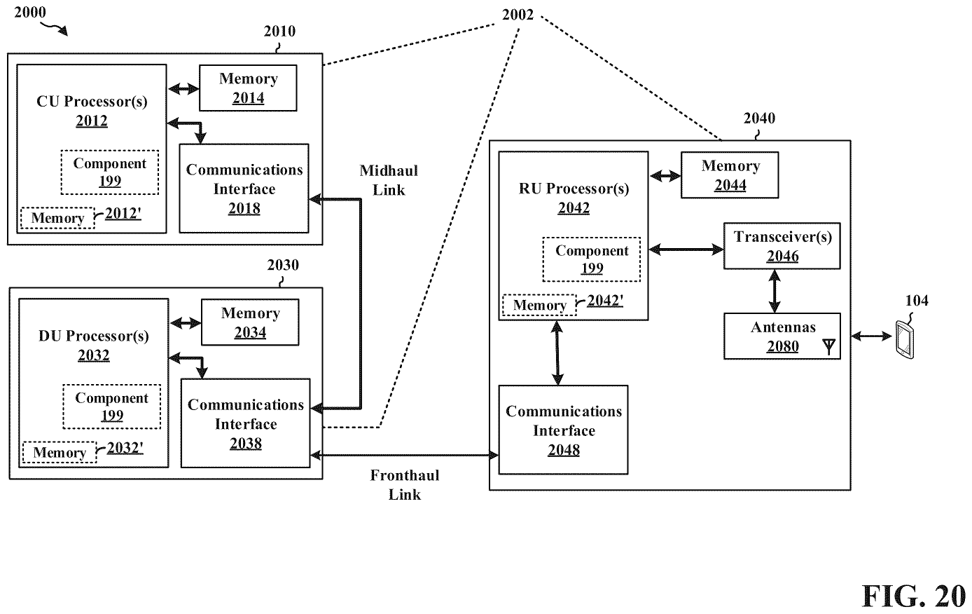

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include at least one CU processor (or processing circuitry) 2012. The CU processor(s) (or processing circuitry) 2012 may include on-chip memory (or memory circuitry) 2012′. In some aspects, the CU 2010 may further include additional memory modules 2014 and a communications interface 2018. The CU 2010 communicates with the DU 2030 through a midhaul link, such as an F1 interface. The DU 2030 may include at least one DU processor (or processing circuitry) 2032. The DU processor(s) (or processing circuitry) 2032 may include on-chip memory (or memory circuitry) 2032′. In some aspects, the DU 2030 may further include additional memory modules 2034 and a communications interface 2038. The DU 2030 communicates with the RU 2040 through a fronthaul link. The RU 2040 may include at least one RU processor (or processing circuitry) 2042. The RU processor(s) (or processing circuitry) 2042 may include on-chip memory (or memory circuitry) 2042′. In some aspects, the RU 2040 may further include additional memory modules 2044, one or more transceivers 2046, antennas 2080, and a communications interface 2048. The RU 2040 communicates with the UE 104. The on-chip memory (or memory circuitry) 2012′, 2032′, 2042′ and the additional memory modules 2014, 2034, 2044 may each be considered a computer-readable medium/memory (or memory circuitry). Each computer-readable medium/memory (or memory circuitry) may be non-transitory. Each of the processors (or processing circuitry) 2012, 2032, 2042 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, in some aspects, the component 199 may be configured to receive, at a CU of the secondary node from the CU of a master node, a failure report indicating a failure of an SCG of a UE due to a PSCell change, where the failure report includes a PSCell change type indicator; and transmit, from the CU of the secondary node to a DU of the secondary node, the PSCell change type indicator and an SCG failure type corresponding to the failure of the SCG. In some aspects, the component 199 may be configured to receive, at a DU of the master node from a CU of the master node, an MCG failure information indicating an RLF of a UE; and transmit, from the DU of the master node to the CU of the master node, cell switch information based on the MCG failure information. The component 199 may be further configured to perform any of the aspects described in connection with the flowcharts in FIG. 16, FIG. 17, and FIG. 18. The component 199 may be within one or more processors (or processing circuitry) of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2002 may include a variety of components configured for various functions. In one configuration, the network entity 2002 includes means for receiving, at a CU of the secondary node from the CU of a master node, a failure report indicating a failure of an SCG of a UE due to a PSCell change, where the failure report includes a PSCell change type indicator; and means for transmitting, from the CU of the secondary node to a DU of the secondary node, the PSCell change type indicator and an SCG failure type corresponding to the failure of the SCG. In one configuration, the network entity 2002 includes means for receiving, at a DU of the master node from a CU of the master node, an MCG failure information indicating an RLF of a UE; and means for transmitting, from the DU of the master node to the CU of the master node, cell switch information based on the MCG failure information. The network entity 2002 may further include means for performing any of the aspects described in connection with the flowcharts in FIG. 16, FIG. 17 and FIG. 18. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a configuration for an LTM with an SCG, where the UE has dual connectivity with a master cell group (MCG) and the SCG; and send, based on a determination of a failure or a near failure of the LTM with the SCG, a report, where the report includes one of a failure report corresponding to the failure or the near failure of the LTM with the SCG or an SPR for the LTM with the SCG, where the report includes measurement information and timing information associated with the LTM with the SCG. By enhancing signaling mechanisms and improving the content and reporting of SCG failure information over various network interfaces, such as Uu, F1, or Xn interfaces, the methods improve the accuracy and efficiency of mobility procedures in wireless communication (e.g., in dual connectivity networks), thereby enhancing overall network stability. Additionally, by supporting co-existence of SCG and MCG LTM configurations and facilitating communication of LTM configuration information between network nodes, the methods/improve inter-node coordination and help prevent unnecessary or incorrect mobility actions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a configuration for a lower-layer-triggered mobility (LTM) with a secondary cell group (SCG), wherein the UE has dual connectivity with a master cell group (MCG) and the SCG; and sending, based on a determination of a failure or a near failure of the LTM with the SCG, a report, wherein the report includes one of a failure report corresponding to the failure or the near failure of the LTM with the SCG or a successful primary serving cell (PSCell) change report (SPR) for the LTM with the SCG, wherein the report includes measurement information and timing information associated with the LTM with the SCG.

Aspect 2 is the method of aspect 1, wherein the report includes the failure report, and wherein the method further comprises determining a failure type of the LTM with the SCG based on one of: a delay in an execution of an SCG LTM based on a first timer; an early execution of the SCG LTM; or the execution of the SCG LTM to a wrong PSCell based on at least a second timer, wherein the second timer represents a time elapsed since the execution of the SCG LTM until an SCG failure.

Aspect 3 is the method of any of aspects 1 to 2, wherein the measurement information associated with the LTM with the SCG includes one or more of: layer 1 (L1) or layer 3 (L3) measurements for a serving PSCell or a target PSCell; the L1 or L3 measurements for one or more neighboring PSCells; or the L1 or L3 measurements for one or more LTM candidate PSCells; and wherein the timing information associated with the LTM with the SCG includes one or more of: a timer; or a timing advance (TA) acquisition type for the LTM with the SCG.

Aspect 4 is the method of aspect 3, wherein the TA acquisition type includes one of: a network-provided TA; or a UE-based TA.

Aspect 5 is the method of aspect 3, wherein the report further includes one or more of: a first indication that the UE was configured with the configuration for the LTM with the SCG before the SCG failure; a second indication of whether each neighboring PSCell of the one or more neighboring PSCells is an LTM candidate cell; or a set of LTM candidate PSCells of the UE.

Aspect 6 is the method of any of aspects 1 to 2, where the method further includes receiving, from the network entity, a radio resource control (RRC) configuration, wherein the RRC configuration includes a measurement type indication indicating an inclusion in the report of one or more of: layer 1 (L1) measurements; or layer 3 (L3) measurements; and wherein the measurement information included in the report is based on the measurement type indication.

Aspect 7 is the method of aspect 1, wherein the report includes the SPR for the LTM with the SCG, and wherein the method further comprises determining one or more SPR criteria have been met; and collecting SPR information, wherein the measurement information includes the SPR information.

Aspect 8 is the method of aspect 7, wherein the configuration for the LTM with the SCG includes one or more SPR thresholds, wherein the one or more SPR thresholds are configured by a distributed unit (DU) of a secondary node, and wherein the one or more SPR criteria are based on the one or more SPR thresholds.

Aspect 9 is the method of aspect 7, wherein the configuration for the LTM with the SCG includes initiating node information, wherein the initiating node information comprises one of a master node or a secondary node as an initiating node.

Aspect 10 is the method of aspect 9, wherein the SPR includes one or more of: the initiating node for the SCG LTM; a type of PSCell change; layer 1 (L1) measurements; layer 3 (L3) measurements; or a timer representing a time elapsed since an execution of the SCG LTM until an SCG failure.

Aspect 11 is an apparatus for wireless communication at a UE, comprising: at least one memory; and at least one processor coupled to the at least one memory, the at least one processor is configured to perform the method of any of aspects 1 to 10.

Aspect 12 is the apparatus for wireless communication at a UE, comprising means for performing each step in the method of any of aspects 1-10.

Aspect 13 is an apparatus of any of aspects 11-12, further comprising a transceiver configured to receive or to transmit in association with the method of any of aspects 1-10.

Aspect 14 is a computer-readable medium (e.g., a non-transitory computer-readable medium) storing computer executable code at a UE, the code when executed by at least one processor causes the at least one processor to perform the method of any of aspects 1-10.

Aspect 15 is a method of wireless communication at a secondary node. The method includes receiving, at a central node (CU) of the secondary node from the CU of a master node, a failure report indicating a failure of a secondary cell group (SCG) of a user equipment (UE) due to a primary serving cell (PSCell) change, wherein the failure report includes a PSCell change type indicator; and transmitting, from the CU of the secondary node to a distributed unit (DU) of the secondary node, the PSCell change type indicator and an SCG failure type corresponding to the failure of the SCG.

Aspect 16 is the method of aspect 15, where the method further includes determining, at the CU of the secondary node based on the failure report, the PSCell change type indicator, wherein the PSCell change type indicator includes one of a layer 3 (L3) PSCell change or a lower-layer-triggered mobility (LTM) PSCell change.

Aspect 17 is the method of any of aspects 15 to 16, wherein the SCG failure type indicates one of: a delay in an execution of an SCG LTM; an early execution of the SCG LTM; or the execution of the SCG LTM to a wrong PSCell based on a timer, wherein the timer represents a time elapsed since the execution of the SCG LTM until an SCG failure.

Aspect 18 is the method of aspect 15, where the method further includes receiving, at the CU of the secondary node, from the CU of the master node, SCG UE history information (UHI) comprising the PSCell change type, wherein the PSCell change type includes one of a layer 3 (L3) PSCell change or a lower-layer-triggered mobility (LTM) based PSCell change; and transmitting, in response to the PSCell change type being the LTM based PSCell change, the SCG UHI to the DU of the secondary node.

Aspect 19 is the method of aspect 15, wherein the secondary node is a source secondary node in a successful SCG LTM execution prior to a reception of the failure report indicating the failure of the SCG of the UE, and wherein the failure report further comprises one or more of: one or more LTM configurations; UE context information; a layer 1 (L1) reference signal configuration; or an early uplink or downlink synchronization configuration.

Aspect 20 is an apparatus for wireless communication at a secondary node, comprising: at least one memory; and at least one processor coupled to the at least one memory and, where the at least one processor is configured to perform the method of any of aspects 15-19.

Aspect 21 is the apparatus for wireless communication at a secondary node, comprising means for performing each step in the method of any of aspects 15-19.

Aspect 22 is an apparatus of any of aspects 20-21, further comprising a transceiver configured to receive or to transmit in association with the method of any of aspects 15-19.

Aspect 23 is a computer-readable medium (e.g., a non-transitory computer-readable medium) storing computer executable code at a secondary node, the code when executed by at least one processor causes the at least one processor to perform the method of any of aspects 15-19.

Aspect 24 is a method of wireless communication at a master node. The method includes receiving, at a distributed unit (DU) of the master node from a central unit (CU) of the master node, a master cell group (MCG) failure information indicating a radio link failure (RLF) of a user equipment (UE); and transmitting, from the DU of the master node to the CU of the master node, cell switch information based on the MCG failure information.

Aspect 25 is the method of aspect 24, wherein the method further comprises updating, at the DU of the master node based on the MCG failure information, a configuration for an MCG lower-layer-triggered mobility (LTM) configuration for the UE to obtain an updated MCG LTM configuration, wherein the cell switch information includes the updated MCG LTM configuration.

Aspect 26 is the method of aspect 24, wherein the method further comprises performing, at the DU of the master node based on the MCG failure information, an MCG LTM.

Aspect 27 is the method of aspect 26, wherein the cell switch information includes LTM cell switch command (CSC) information.

Aspect 28 is the method of aspect 24, where the method further comprises receiving, from a secondary node of the UE, a first indication of a first transmission of a secondary cell group (SCG) lower-layer-triggered mobility (LTM) configuration to the UE via signal radio bearer 3 (SRB3); and managing, based on the first indication, a second transmission of an MCG LTM configuration to the UE.

Aspect 29 is the method of aspect 28, where the method further comprises transmitting, to the secondary node, an inquiry for the first transmission of the SCG LTM configuration via the SRB3, wherein a reception of the first indication is based on the inquiry.

Aspect 30 is the method of aspect 24, where the method further comprises transmitting, to the UE, an MCG lower-layer-triggered mobility (LTM) configuration to the UE via a signal radio bearer 1 (SRB1); and transmitting, to a secondary node of the UE, a second indication of a second transmission of the MCG LTM configuration to the UE via the SRB1, wherein a third transmission of an SCG LTM configuration to the UE is based on the second indication.

Aspect 31 is the method of aspect 30, where the method further comprises receiving, from the secondary node, an inquiry for the second transmission of the MCG LTM configuration to the UE via the SRB1, wherein a transmission of the second indication is based on the inquiry.

Aspect 32 is an apparatus for wireless communication at a master node, comprising: at least one memory; and at least one processor coupled to the at least one memory, the at least one processor is configured to perform the method of any of aspects 24 to 31.

Aspect 33 is the apparatus for wireless communication at a master node, comprising means for performing each step in the method of any of aspects 24-31.

Aspect 34 is an apparatus of any of aspects 32-33, further comprising a transceiver configured to receive or to transmit in association with the method of any of aspects 24-31.

Aspect 35 is a computer-readable medium (e.g., a non-transitory computer-readable medium) storing computer executable code at a master node, the code when executed by at least one processor causes the at least one processor to perform the method of any of aspects 24-31.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, from a network entity, a configuration for a lower-layer-triggered mobility (LTM) with a secondary cell group (SCG), wherein the UE has dual connectivity with a master cell group (MCG) and the SCG; and
send, based on a determination of a failure or a near failure of the LTM with the SCG, a report, wherein the report includes one of a failure report corresponding to the failure or the near failure of the LTM with the SCG or a successful primary serving cell (PSCell) change report (SPR) for the LTM with the SCG, wherein the report includes measurement information and timing information associated with the LTM with the SCG.

2. The apparatus of claim 1, further comprising a transceiver coupled to the at least one processor, wherein to receive the configuration for the LTM with the SCG, the at least one processor is configured to receive the configuration for the LTM with the SCG via the transceiver, wherein the report includes the failure report, and wherein the at least one processor is further configured to:
determine a failure type of the LTM with the SCG based on one of:
a delay in an execution of an SCG LTM based on a first timer,
an early execution of the SCG LTM, or
the execution of the SCG LTM to a wrong PSCell based on at least a second timer, wherein the second timer represents a time elapsed since the execution of the SCG LTM until an SCG failure.

3. The apparatus of claim 2, wherein the measurement information associated with the LTM with the SCG includes one or more of:
layer 1 (L1) or layer 3 (L3) measurements for a serving PSCell or a target PSCell,
the L1 or L3 measurements for one or more neighboring PSCells, or
the L1 or L3 measurements for one or more LTM candidate PSCells,
and wherein the timing information associated with the LTM with the SCG includes one or more of:
a timer, or
a timing advance (TA) acquisition type for the LTM with the SCG.

4. The apparatus of claim 3, wherein the TA acquisition type includes one of:
a network-provided TA, or
a UE-based TA.

5. The apparatus of claim 3, wherein the report further includes one or more of:
a first indication that the UE was configured with the configuration for the LTM with the SCG before the SCG failure,
a second indication of whether each neighboring PSCell of the one or more neighboring PSCells is an LTM candidate cell, or
a set of LTM candidate PSCells of the UE.

6. The apparatus of claim 2, wherein the at least one processor is further configured to:
receive, from the network entity, a radio resource control (RRC) configuration, wherein the RRC configuration includes a measurement type indication indicating an inclusion in the report of one or more of:
layer 1 (L1) measurements, or
layer 3 (L3) measurements,
and wherein the measurement information included in the report is based on the measurement type indication.

7. The apparatus of claim 1, wherein the report includes the SPR for the LTM with the SCG, and wherein the at least one processor is further configured to:
determine one or more SPR criteria have been met; and
collect SPR information, wherein the measurement information includes the SPR information.

8. The apparatus of claim 7, wherein the configuration for the LTM with the SCG includes one or more SPR thresholds, wherein the one or more SPR thresholds are configured by a distributed unit (DU) of a secondary node, and wherein the one or more SPR criteria are based on the one or more SPR thresholds.

9. The apparatus of claim 7, wherein the configuration for the LTM with the SCG includes initiating node information, wherein the initiating node information comprises one of a master node or a secondary node as an initiating node.

10. The apparatus of claim 9, wherein the SPR includes one or more of:
the initiating node for the SCG LTM,
a type of PSCell change,
layer 1 (L1) measurements,
layer 3 (L3) measurements, or
a timer representing a time elapsed since an execution of the SCG LTM until an SCG failure.

11. An apparatus for wireless communication at a secondary node, comprising:
at least one memory; and
at least one processor coupled to the at least one memory and, based at least in part on information stored in the at least one memory, the at least one processor is configured to:
receive, at a central node (CU) of the secondary node from the CU of a master node, a failure report indicating a failure of a secondary cell group (SCG) of a user equipment (UE) due to a primary serving cell (PSCell) change, wherein the failure report includes a PSCell change type indicator; and
transmit, from the CU of the secondary node to a distributed unit (DU) of the secondary node, the PSCell change type indicator and an SCG failure type corresponding to the failure of the SCG.

12. The apparatus of claim 11, further comprising a transceiver coupled to the at least one processor, wherein to receive the failure report, the at least one processor is configured to receive the failure report via the transceiver, and wherein the at least one processor is further configured to:
determine, at the CU of the secondary node based on the failure report, the PSCell change type indicator, wherein the PSCell change type indicator includes one of a layer 3 (L3) PSCell change or a lower-layer-triggered mobility (LTM) PSCell change.

13. The apparatus of claim 11, wherein the SCG failure type indicates one of:
a delay in an execution of an SCG LTM,
an early execution of the SCG LTM, or
the execution of the SCG LTM to a wrong PSCell based on a timer, wherein the timer represents a time elapsed since the execution of the SCG LTM until an SCG failure.

14. The apparatus of claim 11, wherein the at least one processor is further configured to:
receive, at the CU of the secondary node, from the CU of the master node, SCG UE history information (UHI) comprising the PSCell change type, wherein the PSCell change type includes one of a layer 3 (L3) PSCell change or a lower-layer-triggered mobility (LTM) based PSCell change; and
transmit, in response to the PSCell change type being the LTM based PSCell change, the SCG UHI to the DU of the secondary node.

15. The apparatus of claim 11, wherein the secondary node is a source secondary node in a successful SCG LTM execution prior to a reception of the failure report indicating the failure of the SCG of the UE, and wherein the failure report further comprises one or more of:
one or more LTM configurations,
UE context information,
a layer 1 (L1) reference signal configuration, or
an early uplink or downlink synchronization configuration.

16. An apparatus for wireless communication at a master node, comprising:
at least one memory; and
at least one processor coupled to the at least one memory and, based at least in part on information stored in the at least one memory, the at least one processor is configured to:
receive, at a distributed unit (DU) of the master node from a central unit (CU) of the master node, a master cell group (MCG) failure information indicating a radio link failure (RLF) of a user equipment (UE); and
transmit, from the DU of the master node to the CU of the master node, cell switch information based on the MCG failure information.

17. The apparatus of claim 16, further comprising a transceiver coupled to the at least one processor, wherein to receive the MCG failure information, the at least one processor is configured to receive the MCG failure information via the transceiver, and wherein the at least one processor is further configured to:
update, at the DU of the master node based on the MCG failure information, a configuration for an MCG lower-layer-triggered mobility (LTM) configuration for the UE to obtain an updated MCG LTM configuration, wherein the cell switch information includes the updated MCG LTM configuration.

18. The apparatus of claim 16, wherein the at least one processor is further configured to:
perform, at the DU of the master node based on the MCG failure information, an MCG LTM.

19. The apparatus of claim 18, wherein the cell switch information includes LTM cell switch command (CSC) information.

20. The apparatus of claim 16, wherein the at least one processor is further configured to:
receive, from a secondary node of the UE, a first indication of a first transmission of a secondary cell group (SCG) lower-layer-triggered mobility (LTM) configuration to the UE via signal radio bearer 3 (SRB3); and
manage, based on the first indication, a second transmission of an MCG LTM configuration to the UE.
